(19) United States
(12) Patent Application Publication
(10) Pub. No.: US 2010/0252647 A1
(43) Pub. Date: Oct. 7, 2010

(54) Benign global warming solution offers unprecedented economic prosperity

(76) Inventor: Ronald S. Ace, Laurel, MD (US)

Correspondence Address: RON ACE, 15706 BOND MILL, LAUREL, MD, 20707, US

(21) Appl. No.: 12/585,217

(22) Filed: Sep. 9, 2009

Related U.S. Application Data
(60) Provisional application No. 61/136,527, filed on Sep. 11, 2008.

(51) Int. Cl. A01G 15/00

(52) U.S. Cl. 239/2.1; 239/14.1

(57) ABSTRACT

The present invention proposes a permanent and prosperous solution to both human global warming (˜0.26 to 0.74° F.) as well as natural global warming (˜7 to 9° F.). It simultan-eously employs all three of the physical laws to thermostatically regulate Earth: Macro solar energy reflection; sequestration of absorbed solar energy; and, enhanced infrared radiation from Earth. Temporal and spatial macro aerosol water evaporation is employed to triple-cool Earth's surface, by way of: 1. Low-altitude atmospheric and oceanic vapor-cooling and/or macro storage of artificial snow; 2. Automatic ascension of lightweight water vapors to high-altitudes for enhanced water-phase-change infrared radiation from Earth, and; 3. Increased cloud coverage to reflect more incoming solar energy. Deep subterranean, high temperature, high pressure, permanent sequestration of macro quantities of absorbed solar energy assists terrestrial surface-cooling, but also duals as retrievable long term solar-energy-storage to power macro evaporators—without requiring conventional fossil or nuclear sources. The present invention has other applications such as: 1. dramatically enhanced space-conditioning efficiency if combined with potable-water-patent U.S. Pat. No. 6,688,129¹, and; 2. long-term macro solar energy storage for totally reliable, boundless solar-electric power. However, the principal objective, by far, is the stabilization of glacial-melting and glacial-growth, in order to permanently stabilize the oceans at their present levels to preserve our vital global seaports. This document endorses both human (AGW or, anthropogenic global warming) and ancient natural global warming processes.

### BACKGROUND OF THE INVENTION

The present application claims the benefit of co-pending Provisional Application No. 61/136,527, filed Sep. 11, 2008, and entitled “A BENIGN GLOBAL WARMING SOLUTION OFFERS UNPRECEDENTED ECONOMIC PROSPERITY”, the disclosure of which is hereby incorporated herein in its entirety by reference.

The present comprehensive invention represents the first practical, non-toxic, affordable, rapidly achievable, and even prosperous, permanent solution to stable planetary temperature control, plus the byproducts—unlimited, low cost, clean, solar-energy-storage and macro space conditioning.

The present invention is directed primarily at macro-minded scientists, industrial, and geopolitical policymakers, for it represents unprecedented multi-trillion dollar global economic prosperity—potential, the fruits of which include copious worldwide clean energy, food, and fresh water. The present invention complements U.S. Pat. No. 6,688,129—a potable-water macro-energy delivery technology.

The thermodynamics of Earth must first be clearly defined before climate solutions are offered. The surface of planet Earth is not merely warm, it is 512° F. hot, and it is also slightly dehumidified as well. A central tenet of global warming is that human greenhouse gas emissions are melting worldwide glaciation—even high altitude snowcaps at the equator (Kilimanjaro). New research reveals that natural constant melting combined with reduced snowfall (low planetary humidity) is the cause. Thus, the present re-humidification invention is further justified. Were it not for solar warming to a cozy average planetary temperature of about +58° F., the surface of Earth would be 454° F. below zero—the temperature of deep space (2.7° K/−454° F./5° R). Earth's crust is so thick and such a good thermal insulator that the red-hot deep core heat only warms the surface by a fraction of one degree. Solar energy (1.73×10¹⁷ watts or, 173 PW) is overwhelmingly Earth's surface and atmospheric heater as well as the prime energy source for all life, as depicted in FIG. 1. As there illustrated, 20.2% of incoming solar energy is reflected by clouds, 5.8% is reflected by the atmosphere, and 4% is reflected by the ocean.

Ocean levels are presently low compared to historical averages (FIG. 2). Earth's glaciation, and particularly the polar ice caps, contain enough water to flood the planet with about 120 meters (390 feet) more liquid water. If Greenland ice alone were to melt (or its glacier slide into the ocean), all of earth's oceans would rise by about 25 feet—thereby rendering all of man's seaports and coastal infrastructures useless. That, in turn, would severely limit man's import of winter foods and the bulk of man's other vital materials, including oil, coal, gas, and the like. Credible sources have calculated that if oceans were to rise just 25 feet, up to 5 billion people would be at risk. One major conclusion can be drawn from this. Mankind must find safe ways to stem the melting of glaciers, worldwide. Mankind can neither survive severe melting nor can we survive significantly increased glaciation on earth. The vital conclusion is that we must permanently stabilize the present planetary ice as we now know it. See the violent historical sea level changes in FIG. 2.

FIG. 2 illustrates a 500 million year estimate of sea levels above present levels. Glacial melting (both poles plus other glaciation) can raise the present oceans by 390 feet above present levels. A mere 10-25 feet rise can decimate most seaports. Moreover, the loss of our present massive 80-calories-per-gram glaciation latent heat (energy) absorbers, will almost certainly* briefly spike earth's surface temperature extremely high under constant solar heating (and no latent heat absorption), although no historical record yet proves that assertion. Evidence [2001 IPCC and Fairbanks 1989] indicates that oceans have risen 120 meters (393 feet) since the last glacial maximum approximately 18,000 years ago (2.2 ft/century and accelerating). The vivid glaciation retreats from the middle U.S. and Europe, all the way north to northern Canada and Russia, coincides with the observed rising oceans. This completely natural net glacial melting process must now be halted to preserve coastlines and seaports. Earth's natural gyrations need no human intervention. But humanity's mere 200,000-year evolution and survival now depends on stable glaciation/coastlines.

FIG. 2a illustrates the rapid loss of seaports . . . the “20,000 year wave”. There is little debate over natural melting of ice during 1993-2003 (˜7×10¹⁴kg/yr). Long before human greenhouse effects, very pronounced natural global heating (FIG. 4) and natural flooding during just the last 20,000 years have rapidly eroded shorelines inland by ˜200 miles (over 50 ft/year or, ˜4,800 to y 2100). More importantly, human global warming and glacial melting are accelerating coastline encroachment and destroying Man's vital seaport infrastructures—our global highways for vital food supplies, gigatons of energy shipments, and raw materials for billions of people. This historical process is not controversial.

Some argue that there is no urgency for planetary climate control. In fact, few know enough about the subject to care at all. Many have presented compelling evidence that Man is the cause of global-warming, largely a result of human greenhouse gas emissions. That consensus asserts that Man has warmed the surface of earth by about ˜0.26 to 0.74° F. (pg 11). Many others dispute it. (See, for example http://www.sepp.org/publications/NIPCC-Feb%2020.pdf, which asserts that natural warming is the issue, not human emissions.). Proponents argue that Man's greenhouse gases can heat earth by up to ˜3° C. (5° F.) by 2100. Others claim +0.02° C.⁹. To bring this into perspective, we need to appreciate the 5,400,000 year historical evidence of earth's temperature swings and numerous ice ages long before Man appeared—a mere 150,000 years ago.

FIG. 3 Illustrates the Earth's gradual cooling and Earth's natural “thermostat”. Very few degrees of cooling creates an ice age. Very rapid warming spikes are almost always followed by a plunge toward an ice age. The very long term mean temperature is slowly falling as Earth continues to cool, as the most recent instabilities intensify.

FIG. 4 illustrates the shorter term (450,000 years) depiction of mean global temperatures. The approximate “IDEAL” mean temperature, which would stem melting and stabilize glacial-building, is about 2 to 2.5° C. cooler. Note that 127,000 years ago, Earth peaked at about 6° C. (11° F.) hotter than today and that just 6° C. cooler than today begets an ice age.

FIG. 5 illustrates that CO₂ concentrations largely match the ice age cycles—that is, CO₂ RISES with warmth, with or without mankind present. As discussed herein, ocean waters presently contain about 40,000 gigatons of dissolved CO₂ and that warmer water dissolves less CO₂. Thus, oceans NATURALLY release massive CO₂ gases when warmed. Re-dissolving the CO₂ takes much more time.

Note in FIG. 5's insert—the sharp rise of CO₂ concentration (>380 ppm) during the “industrial revolution”, is not yet accompanied by a rapid or dramatic global temperature increase. Earth has been swamped with over 4000 ppm CO₂ (as well as other more powerful greenhouse gases) long before mankind arrived. There is little debate that man is indeed contributing to greenhouse gases and at least some global warming. However, one pronounced property of CO₂ is that almost half as much will dissolve in 20° C. water as in 0° C. water (1743 ppm vs 3312 ppm at 0° C.). In other words, about 78 ppm (0.008%) less CO₂ will dissolve per 1° C. warmer water. Thus, since ˜40,000 gigatons (4×10¹³ tons) of CO₂ are presently dissolved in the oceans, then each 1° C. global temperature increase (for any reason) can release ˜0.008%×4×10¹³ tons or, 3.2 gigatons more CO₂ into the atmosphere per ° C. [e.g. 48 gigatons per 15° C. planetary-rise (FIG. 4) from the oceans or, +2.4% of the ˜2,000 gigatons in the atmosphere during the last ice age—plus the even larger CO₂ release from melting permafrost areas]. Thus, a disturbing question arises from this observation: “Which came first—natural global heating or, greenhouse heating?” This cause-and-effect debate is inconsequential to the present invention. It is merely an important observation foddering scientific uncertainty. What are indeed paramount to mankind's survival are the consequences if massive ice melting continues. To that end, we need not focus on small secondary greenhouse effects of solar heating. We must focus on the primary heater itself—solar energy intercepted, absorbed, and converted into heat on the surface of earth. That alone actually melts ice. And that is precisely the focus of the present invention.

FIG. 4 illustrates Earth's last 450,000 year thermodynamic average natural temperature—approximately 2-2.5° C. (3.5-4° F.) cooler than today (see the “ideal” temperature). In other words, all the natural forces are attempting to maintain earth at a central-temperature of about 54.5° F., where ice-buildup would be neither increasing nor decreasing—not the present 58° F. mean temperature, where all global ice is experiencing a meltdown. Ideally, if we could very cost-effectively reduce and permanently maintain earth approximately 3.5-4° F. cooler, the inevitable global flooding would be averted. Moreover, if such an ambitious macro undertaking were also accompanied with significant global economic prosperity too, it would be far more welcome than all of the prior art proposals to reduce human greenhouse emissions (˜0.26 to 0.74° F.). The present invention can halt melting.

Note the peak temperature in FIG. 4 (+6° C. hotter than today) and the lowest ice-age temperatures of about 9° C. cooler than today . . . a natural delta-T range of about 15° C. Therefore, for at least 450,000 years, Earth has been naturally attempting to regulate itself at about a mean temperature of 7.5° C. midway between the +6° C. peaks and the −9° C. valleys. This translates to a stable middle absolute temperature of about 12.5° C. (54.5° F.), not the 14.5° C. (58° F.) present mean global temperature. But such a stable central 12.5° C. absolute temperature happens at about 2° C. (3.5° F.) cooler than today. Earth has a natural thermostat set at about 54.5° F. (12.5° C.). It should also be emphasized that the exact amount of persistent ice at precisely 12.5° C. is not known. Mankind is hereby urged to cool Earth slightly more than 2° C. to preserve our glaciation exactly where it is today. Such “persuasion” is only even remotely possible if an extremely efficient, safe, and even reversible, temperature control technology is employed—as the present invention makes claim.

The realizations in FIG. 4 are very important. They demand that if mankind is to avert catastrophic worldwide sea level changes (up or down) to preserve the vital seaports and coastlines, very practical and extremely affordable ways and means must be immediately implemented. There is no time to waste to achieve the desired goals to reduce the average global temperature by roughly 2° C. (3.5° F.) to 2.5° C., where glaciation would be more stabilized. The most recent reports conclude that the current average 58° F. global temperature is melting both poles as well as worldwide glaciers and tundra at alarming rates—a melting rate that far exceeds man's rather small estimated +0.26 to 0.74° F. green-house contribution. In other words, the +3.5° F. to +4° F. natural melting process is about 5-14 times greater than the “human greenhouse” melting process. However, such ambitious global temperature regulation is by no means a small task. The task is so great that it absolutely must be inexpensive and it requires macro-minded leadership. If we are to accept the actuarial cost estimates of global warm-ing projections in FIG. 6, man will sacrifice about 5-20% of our present $63 trillion global economy. That amounts to a global cost of ˜$3 to $13 trillion per year in economic damages. Most macro-economists agree that such a global economic burden cannot be sustained and that sequestering greenhouse gases is also unaffordable. Many scientists do not even believe that this risky plan will even work. It must be emphasized that merely reducing human greenhouse emissions (only 0.74° F.) is but a small fraction of the actual ice-stabilization task. Natural melting has been accelerating for ˜18,000 to 20,000 years. No prior art proposals to cool earth even hint of a practical and profound undertaking 5 times greater than human greenhouse warming. The present invention does just that.

FIG. 6 illustrates mere human global warming cost impacts. “15%” of the $63 trillion global economy is an unaffordable $9.5 trillion per YEAR. to permanently solve the 5-times larger “natural” global heating issues have heretofore been unthinkable. The present invention proposes to not only dramatically halt human global warming, but it also proposes to halt natural melting prosperously, not a financial burden.

Referring to FIGS. 4 and 7, mankind's predicament distills to this. Hypothetically, if we actually had practical technology to thermostatically regulate the planet, as claimed by the present invention—what would be the ideal average global temperature? That question is no longer meaningful. Mankind no longer has that luxury. An even warmer (than today) average temperature would catapult mankind into global flooding—a loss of global seaports. Likewise, too much cooling would increase global glaciation and drop ocean levels farther than they are today, producing dry-docks and also destroying seaports and vital coastal ecologies. In other words, if we are to preserve ocean seaports and vital coastlines, in order to survive, we have but one choice—we must maintain ocean levels where they are today. That, in turn, demands that mankind must equilibrate glaciation rates with melting rates. That equilibrium is astonishingly close to balance naturally. Earth's long-term, life sustaining, natural thermostat is set at ˜+514° R+/−14° R or, a precision of +/−1.3%!

FIG. 7 illustrates Earth's largest glacial periods. Earth is presently at the middle of an ice age—which must now be preserved to avoid 390 additional feet of oceanic global flooding. Civilization cannot risk losing many thousands of years of human coastal infrastructure evolution. During each of the multi-million year major ice ages, there have been more than 100 violent glacial advances and retreats (FIG. 2). This time, a constant glaciation condition is man's only choice—no less and no more ice. Earth is currently far too hot with glacial meltdown at the halfway point, and it must be cooled and regulated at about 2.5° C. cooler (FIG. 4).

### II. Global Humidity, Clouds And De-Forestation Control Solar Reflectivity

If the rapid global warming projections in FIG. 8 were not alarming enough, consider Earth's expanding deserts in FIG. 9. Desertification agrees with the low oceanic levels depicted in FIG. 2. However, the dilemma is not just dealing with glacial melting and global starvation, but expanding global deserts too. Warming produces lethal flooding and global starvation, but excessive cooling also leads to ecological decimation and starvation. Earth is simply too hot and the atmosphere too dry. The unified planetary solution, which accommodates both warming and humidity, rests in selectively humidifying the needy parts of the planet, while simultaneously attenuating the solar energy absorbed on Earth's surface. Artificial macro water evaporation produces more clouds, which safely reflect solar energy while simultaneously re-hydrating the planet, as detailed in the present invention.

In fact, this document will conclude that the additional amount of evaporated water to halt global warming, and especially to halt oceanic flooding, happens to be approximately equal to the total glacial melting (˜7×10¹⁴ kg/year during 1993 and 2003 and accelerating to >1.5×10¹⁵ kg/yr by 2100). Although this document employs global aerosol cooling physics as the method to estimate how much water must be artificially evaporated, it is somewhat confirmative and comforting to learn that the estimated volume of evaporated water needed for global cooling is also capable of maintaining global glaciation and halting ocean flooding. The range of calculated water evaporation, depends on where the water evaporators are physically located, but the range is estimated at about 0.5 to 10 times the volumetric melting glaciation. The range of evaporated water is sufficient to deposit as much solid water (ice) as that which constantly melts. Thus, sea levels can be stabilized by atmospheric humidification as Earth is thermostatically regulated at a slightly cooler average temperature.

FIG. 8 illustrates various global warming projections. The present invention proposes a practical remedy. FIG. 9 illustrates vast expanding global deserts. Although some parts of the world are very humid, such as equatorial rain forests, many other places are dry, inviting water vapor. Water vapor is imbalanced.

Natural macro deforestation has recurred many times throughout history. Ice ages periodically devastate the natural hydrology on earth. However, there is a new man made growing problem comparable to natural ice age deforestation. Man has, and continues to, harvest the largest trees at voracious rates. Many tens of billions of trees, and especially LARGE trees, have been harvested and only sparsely replaced by much smaller ones. Of course, all plant life plays a significant role in planetary CO₂ cycling, but trees uniquely play a major role in the planet's hydrology. Large trees uniquely perform deep hydrological transpiration, unequaled by any other process on earth.

Large trees, a favorite commercial target, have the unique ability to send deep roots into the upper level of the gigantic underground aquifers that ordinarily do not play a part in Earth's powerful hydrological cycle—depicted in FIG. 10. Most large trees can transpire (carry water from the roots and evaporate it through the leaves) hundreds of gallons PER DAY. Hence, the destruction of tens of billions of slow growing large trees has a major negative impact on hydrating the planet. Harvesting large trees destroys a huge source of clouds and vital rainwater for other parts of the world.

Note in FIG. 10, which illustrates the Earth's “water cycle” from American Geophysical Union data, the 71×10¹⁵ kg of “evaporation and transpiration” from the land, and the 434×10¹⁵ kg of oceanic evaporation (total evaporation=505×10¹⁵ kg/year), which normally take place today. Scientists estimated that 41×10¹⁵ kg (38% of the 71×10¹⁵ kg land evaporation) is by transpiration, for big trees uniquely tap the top of Earth's largest fresh water (15,300×10¹⁵ kg) aquifer. However, recent deforestation and desertification (FIGS. 11 and 9) can account for the disappearance of a significant portion of today's missing evaporation (and missing cloud coverage). Destruction of large and heavily transpiring trees (hundreds of gallons/day/tree) in equatorial regions has an impact on Earth's hydrological cycle, but a considerably larger impact if harvested from northern or southern Ferrel Cell hemispheres, where cloud longevity is highest. Water vapor is much lighter than air and rapidly rises. Therefore, water transpired by equatorial trees rapidly rise into a very humid atmosphere, rapidly forming clouds, which only briefly reflect solar energy, and then precipitate as rain soon after transpiration. Rapid precipitation equatorial clouds do not reflect as much solar energy as longevity clouds. When non-equatorial large trees are destroyed, the clouds that they would have produced, would have lasted considerably longer and reflected much more solar energy. The consequence of deforesting non-equatorial large trees not only produces significantly higher global warming via fewer longevity clouds, the loss of transpired water adds to global desertification too. FIG. 11 vividly depicts the massive deforestation in just the United States. The very same thing took place in Europe long ago and is taking place at more than alarming rates all over the planet.

As elaborated later in this document, it is theorized that there were upwards to 2-3 times more large trees long ago, which were mowed down by advancing glaciers and are currently transpiring only 41×10¹⁵ kg of water (compared to perhaps 80-120×10¹⁵ kg long ago), and therefore, are now producing fewer clouds than thousands of years ago. Less hydration and fewer clouds now allow more solar energy to warm the planet (during the last 20,000 years in FIG. 4).

FIG. 11 illustrates old-growth deforestation in the United States. Predictions of continuous global deforestation by 2080 look very similar. The global hydrologic cycle and fewer clouds add to solar heating. Reduced large-tree transpiration not only reduces cloud coverage, but leads to more desertification, which causes even more large-tree deforestation. The combined profound impacts of planetary de-humidification and reduced cloud coverage are vividly simplified in FIG. 12 Illustrating that the Earth's combined clouds (20.2%); atmosphere (6%); and land (4%) reflections total 30% of the 173×10¹⁵ watts of intercepted solar energy. See FIG. 1 for data source. The present mean temperature is ˜58° F. (One petawatt=1,000,000,000,000,000 watts).

There is an interesting corollary to this deforestation discussion, namely—is it even possible for too many large trees to have ever existed? Would too many heavily transpiring large trees (plus other vegetation) produce too many clouds? As geologists well know, all of Greenland, Iceland, Europe, and many other places on Earth were heavily blanketed with such growth—before 20 million years ago (pgs 526 and 620 of Elements of Geology (1903) which may be found at: http://books.google.com/books?id=xUINAAAAYAAJ&pg=PA101&1pg=PA101&dq=%22volcanic+water%22&source=web&ots=882z4u7Go&sig=Rj55rHEy9AwFRozi5jsyf0PRo7U&h1=en#PPP5,M1). Look again at FIG. 7 to see when our current ice age began—roughly 20-30 million years ago. Even palm trees migrated to Greenland and northern Europe.

FIG. 12 is the basis for the solar reflection embodiment of the present invention. FIGS. 1 & 12 illustrate what can be done to reduce the mean global temperature from today's 58° F. to a new stable ideal mean planetary temperature of approximately 54.5° F., a decrease of approximately 3.5° F. to perhaps 4° F. FIGS. 1 & 12 illustrate that 88 petawatts of solar heat is presently reaching the surface of Earth, which results in a +512° F. surface-temperature rise or, ˜5.82° F. per absorbed PW. Thus, to reduce Earth's mean temperature by ˜3.5° F., about 3.5/5.82 or, 0.6 additional petawatts must somehow be artificially “removed” from Earth. If 0.6 PW were “removed” solely by extra cloud reflections, then the presently reflected 35 PW must be increased by approximately 1.71% to 35.6 PW. Conversely, if 0.6 PW solar energy were solely “removed” from Earth by increased infrared radiation, the present 40 PW of radiated infrared energy would have to rise 1.5% to 40.6 PW. But, as will be elaborated, cloud reflections and infrared radiation are additive—and are also not the only available physics mechanisms to remove 0.6 PW to thermally regulate Earth at about 54.5° F.

Simultaneous solar reflections, enhanced infrared radiation, plus sequestered incoming solar-energy, are simultaneously possible.

FIG. 10 indicates that the average terrestrial+marine steady state atmospheric water content is 14.5×10¹⁵ kg. FIG. 10 also indicates the total annual precipitation as 396×10¹⁵ kg+107×10¹⁵ kg or, 503×10¹⁵ kg, which of course, must be identical to the annual global evaporation. These evaporation rates also sustain the present 35 petawatts of natural cloud reflections (FIG. 1). Thus, to increase cloud reflections from 35 PW to 35.6 PW (1.71%), the mean cloud coverage must increase by 1.71% and the global evaporation rates must increase by 1.71% from 503×10¹⁵ kg to 511.6×10¹⁵ kg/yr—an increase of 8.6×10¹⁵ kg/yr of additional evaporated water. However, such a target-evaporation is based on erroneous presumptions—that solar reflections are the sole mechanism to remove 0.6 PW of solar energy; that clouds have a fixed persistence time; and that no additional infrared radiation occurs. Cloud persistence can be increased and very large infrared radiation does accompany artificial water evaporation. Under the right conditions, cloud persistence can be greatly prolonged.

For example, equatorial rainforest clouds are very thick and rapidly precipitate evaporated water. Short-lived, thick equatorial clouds do little to reflect solar energy compared to more numerous, thinner, and more persistent clouds. Improved cloud longevity in non-equatorial areas can markedly increase cloud-longevities and thereby reduce the amount of artificially evaporated water—in some cases, resulting in greater than a ten fold reduction in evaporated mass, to obtain the same reflected solar energy. In other words, if average cloud persistence is indeed increased 10-fold, then only 1/10^{th} as much water (perhaps only 8.6×10¹⁴ kg) would need to be artificially evaporated to cool Earth to 54.5° F. and to reflect an additional ˜0.6 petawatts. Clouds do not need to be thick rain-clouds to reflect solar energy. A mere few hundred feet of thin clouds can reflect the bulk of incident solar energy. Excessively “dark” rain clouds, many thousands of feet thick, readily produce precipitation but reflect only a tiny fraction more solar energy compared to many thin clouds. Precipitation is not the first priority of the present invention. Daytime cloud longevity is. Of course, it is obvious that evaporating more water into the atmosphere will eventually produce more precipitation. More precipitation is unavoidable. But the first priority is to make more numerous and more persistent daytime-clouds (not nighttime clouds), to maximize the amount of reflected solar energy with a minimum of applied input energy to macro-evaporate water.

As illustrated in FIG. 12a, thin clouds, only hundreds of feet thick, cast dark shadows and reflect large amounts of solar energy. A light meter located under this thin cloud, facing the sun, would measure only a small fraction of the direct solar intensity. This thin, small diameter cloud continuously reflects tens of gigs joules of solar energy away from Earth every second and it would reject PETAJOULES (>10¹⁵j) in about 10 hours. Therefore, Earth's daytime cloud longevity—even 1% higher persistence—is extremely instrumental in cooling Earth.

Therefore, the above first solar reflection approximations illustrate how Earth can be cooled to the desired ideal temperatures and that the greater the average longevity of each new cloud, the lower the demands on the amount of artificial evaporation. However, other laws of physics enable much less evaporation to achieve the same planetary cooling objective. Vast infrared radiation is also involved.

Hypothetically, if cloud coverage and cloud-reflectivity remained absolutely fixed and new macro water evaporation systems were introduced, the average temperature of Earth would still drop sharply by infrared cooling. As illustrated in FIG. 1, Earth's surface temperature is presently elevated ˜512° F. by the 88 PW of solar energy which actually reaches the surface (5.82° F./petawatt). The previous over-simplified extra cloud coverage showed that they can reflect 0.6 petawatts of solar energy and reduce Earth's mean temperature by about (0.6 PW)×(5.82° F. per PW) or, 3.5° F. But Earth also radiates even more infrared energy than the solar energy reflected by clouds (40 PW vs 35 PW by clouds). Thus, if 8.6×10¹⁴ kg to 8.6×10¹⁵ kg of additional water is artificially evaporated, then low altitude thermal energy must be consumed in the vaporization process. This is called “vapor cooling”. To be more exact, it takes 540 calories of low altitude heat to evaporate each gram of water (540,000 cal/kg). Referring once more to FIG. 1, it is clear that when water at the surface of Earth evaporates, the evaporation process itself demands tremendous thermal energy to account for the liquid-to-gaseous phase change. FIG. 1 illustrates that Earth's surface presently gives up approximately 40 petawatts of heat to evaporate water (3.02×10²³ cal/yr). That vapor-cooling heat flux must be fully accounted. All of the latent heat energy is extracted from the lower atmosphere and the lightweight water vapors rapidly ascend to eventually radiate infrared energy into space from the heated upper atmosphere. The water-evaporation energy traverses several steps along the way before the infrared energy is actually liberated. Water vapors rise rapidly because they are almost one half the weight of air. When they rise, they quickly cool and condense back to liquid water (and ice too), thereby giving up all of their gas-to-liquid phase-change thermal energies to the upper atmosphere, which, in turn, liberates infrared radiation energy to space before liquid water again falls to Earth. This entire process is nearly identical to a giant “heat pipe”. Thus, the act of evaporating liquid water at Earth's surface not only produces more cloud coverage to reflect additional sunlight—more infrared energy (40 vs 35 petawatts) is also naturally liberated.

The infrared radiation associated with artificially evaporating 8.6×10¹⁵ kg/yr corresponds to an evaporative power of 2.54 PW, which, in turn, would cool Earth far too much. 2.54 PW×5.82° F./PW corresponds to 14.8° F. over and above the 3.5° F. cloud reflective cooling (18.3° F. total temperature drop). Thus, infrared radiation is a very powerful cooling tool, and much less than 8.6×10¹⁵ kg/yr evaporated water is required. Even if average cloud persistence were increased 10-fold, and the evaporated water reduced 10-fold to 8.6×10¹⁴ kg/yr, the infrared cooling component would still be 1.48° F. over and above the 3.5° F. cloud reflective cooling. Therefore, the combined cloud reflections and infrared radiation allow still less water-evaporation to achieve the target 3.5° F. planetary cooling. One option would target as much as 3° F. longevity cloud-cooling plus 0.5° F. infrared cooling to achieve 3.5° F. Under this combined cooling assumption, only about 5.7×10¹⁴ kg/yr would be needed. It is clear that infrared cooling is even more effective than ordinary cloud-solar-reflections. But persistent clouds (e.g. 10 times more persistent than Earth's present mean cloud life-spans) would require much less water evaporation, and cloud reflective cooling would dominate the present macro evaporation invention. Otherwise, infrared radiation would be the dominant cooling mechanism over short-lived clouds. Clearly, there is a large potential cooling multiplier by cloud longevity. Surface vapor cooling is normally a one-time event, whereas persistent clouds can continuously reflect incoming solar energy. That's why highly persistent cloud coverage is preferred.

### BRIEF DESCRIPTION OF THE DRAWINGS

The foregoing and additional objects, features and advantage of the present invention will be better understood from the following detailed descriptions of preferred embodiments thereof, taken with the accompanying drawings, in which:

FIG. 0 is a diagrammatic illustration of a preferred non-clogging, centrifugal, aerosol device which sprays very fine droplets of seawater into the air for rapid evaporation of water, but allowing a small fraction of very salty droplets to return to the ocean.

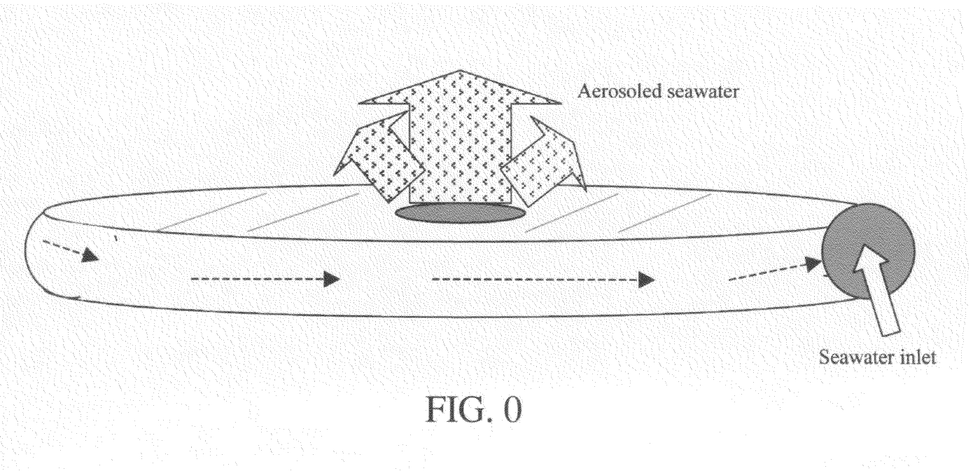

FIG. 1 illustrates the normal distribution of solar energy befalling earth which presently maintains earth at inhabitable temperatures, where one Petawatt=10¹⁵ W. (NASA data) and where causes of reflections include: Clouds 20.2%; Atmos=5.8%; Surf=4%.

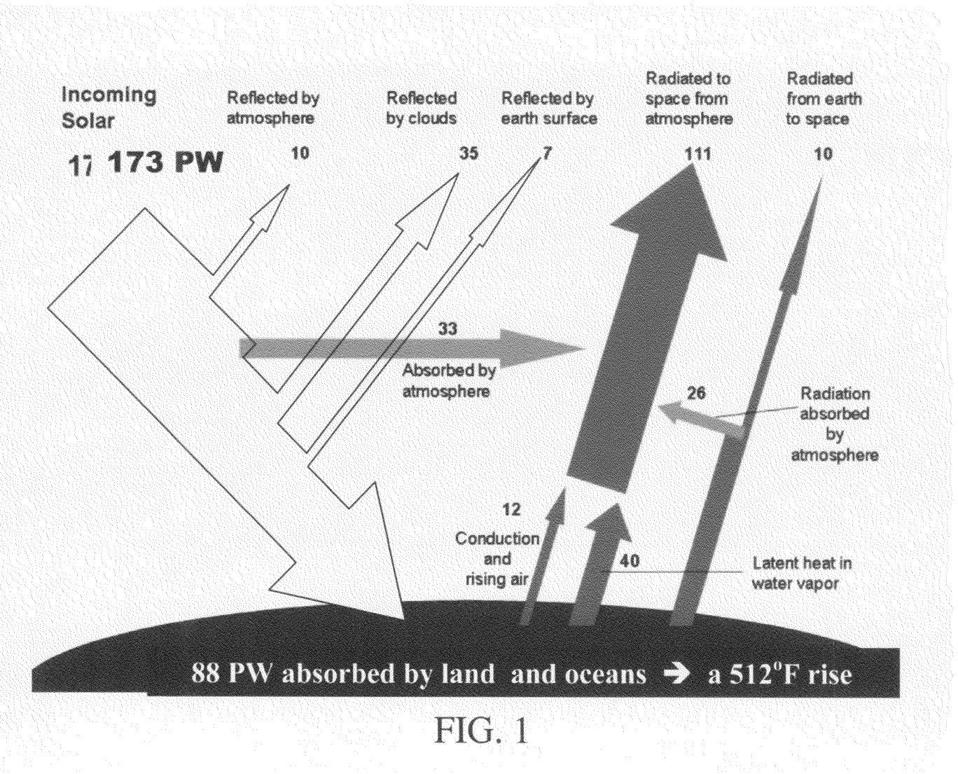

FIG. 2 is a graphic historical record of natural sea level gyrations, which up to 80-90% of modern civilization probably cannot survive. Planetary thermal regulation is now essential for the first time.

FIG. 2a is a pictorial display of the rapid encroachment of the Atlantic Ocean on North America.

FIG. 3 illustrates twelve 100,000-year mini ice ages during just the last one million years, about 35 41,000-year mini ices during the preceding 1.6 million years, as well as the gradual cooling trend of earth.

FIG. 4 depicts how earth's volume of ice follows the cyclic nature of the mean temperature and that earth is presently about 2.5° C. hotter than the mean temperature of the last 450,000 years, which is the principal cause of global glacial melting, which the present invention proposes to stabilize.

FIG. 5 illustrates CO₂ variations during the last 450,000 years, with particular emphasis on the recent rapid rise of CO₂ with natural deforestation and desertification, plus the even more recent human emissions and deforestation effects.

FIG. 6 illustrates just some of the many positive economic benefits of the present invention compared to other proposals which only address correcting human greenhouse warming, whereas the present invention represents the only known practical and benign solution to overcoming natural global warming, which is many times more severe and threatening than mere human warming.

FIG. 7 illustrates the big picture of a billion years of four of the greatest natural ice ages, with emphasis on today's glaciation state, which cannot significantly vary from now on, if civilization, as we know it, is to be maintained.

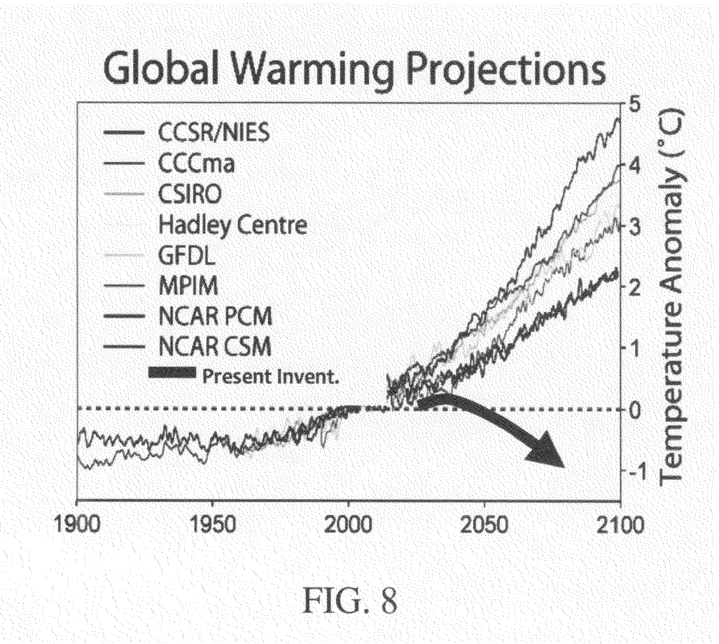

FIG. 8 is a graphical representation of 8 academic studies which predict significant global warming. Note that the present benign global warming invention is the only one which predicts significant global cooling, and thus, both glacial and sea level stabilization.

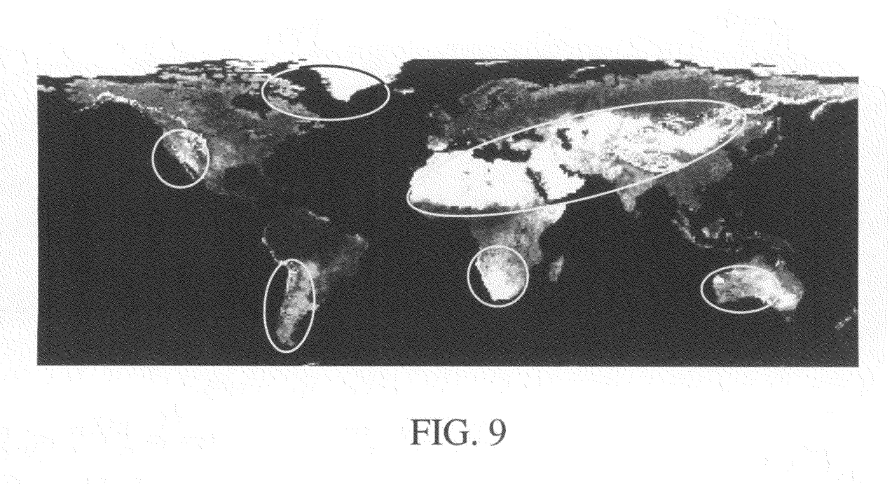

FIG. 9 designates the major and locations for the present invention. These largely desert shorelines are by no means the only locations. There are hundreds, if not thousands of other preferred locations and desolate islands which are also suitable.

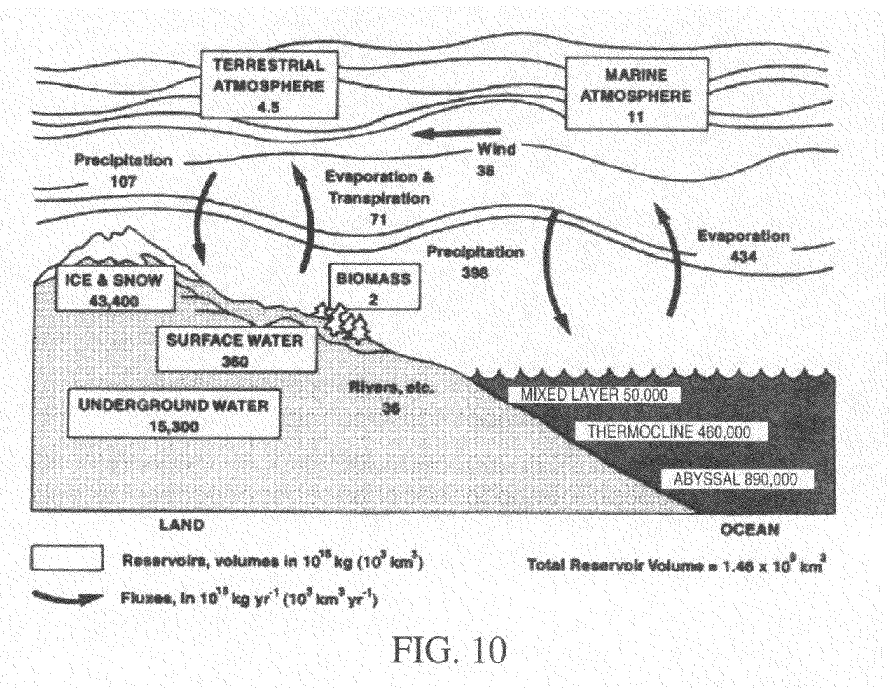

FIG. 10 depicts earth's well known “water cycle” which is currently in a slightly arid condition, partially due to massive natural and human deforestation.

FIG. 11 illustrates the drastic deforestation which has recently taken place in just North America. Observations, documentation, and future predictions on a global level is taking place. This is a major contribution to global dehydration, and other effects.

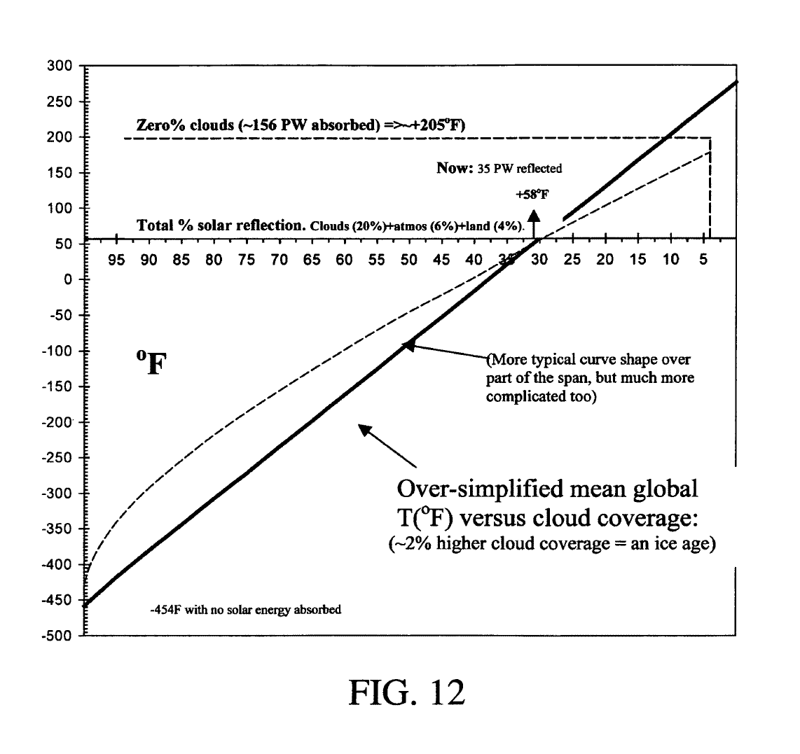

FIG. 12 is a crude depiction of the astounding power of solar radiation in raising and maintaining the surface of earth at inhabitable temperatures. Far too many complications make a detailed thermal representation useful.

FIG. 12a captures a visual glimpse of the ability of even small clouds to shelter earth from excess solar radiation.

FIGS. 13 and 13a illustrate two methods to capture and sequester solar energy, thereby cooling earth's surface temperature but also allowing mankind to release it as a clean and totally reliable energy replacement of fossil and nuclear power.

FIG. 14 illustrates one of many prior art proposals to correct only the small human greenhouse warming effect. It proposes producing longevity artificial clouds near sea level with a large fleet of large seaworthy ships, which heavily rely on exposure to only mild breezes, and which produce none of the many positive economic benefits or the CO₂-sequestration byproducts of the present invention.

FIG. 15 illustrates a prior art method to distribute the stored or sequestered macro thermal energy in FIGS. 13 and 13a.

FIG. 16 merely illustrates normal cloud dynamics of earth which play such a large role in regulating the average temperature of this planet.

FIG. 17 depicts earth's 6 macro air circulation cells which convey vast quantities of water vapor from the two Hadley Cells via the two Ferrel Cell loops, to both poles, which is where most of the planet's glacial storage is located, and which, if allowed to naturally melt, as has happened hundreds of time before, will flood most of the civilized world and cut off the flow of much of our food, energy, and raw material supplies.

FIG. 18 illustrates how the solar energy sequestration methods of FIGS. 13 and 13a may also be used to store ‘cold energy’ and to distribute it by prior arts similar to distributing hot energy by the same potable water prior art distribution system.

FIG. 19 is merely a typical example of global solar power patterns. The western coast of the southern United States is both and and has abundant solar power, similar to west Africa, western South America, and western Australia. Note the proximity to endless supplies of sea water which can be evaporated and allowed to form planetary-cooling clouds which also can help to re-hydrate vast and expanding desert areas, by simultaneously deploying earth's natural air circulation cells to convey fresh water where it is most needed.

### DETAILED DESCRIPTION OF THE PRESENT INVENTION

From the above reflective plus radiative cooling discussions, it can be readily understood that there are at least two additive cooling effects associated with evaporating surface waters and that the combined objective is that of reducing planetary solar heating by about 0.6 petawatts in order to achieve a more stable and “ideal” mean planetary temperature of about 54.5° F.—where life-sustaining seaports can be permanently preserved.

The beauty in the present invention lies in the fact that latent-cooling always assists cloud reflection cooling. These two cooling processes are automatically additive. Very long cloud persistence requires the least water-evaporation and thus, the lowest input energy, and of course, the lowest operating cost to cool and permanently maintain Earth at about 54.5° F. Although fresh water can be evaporated, seawater is preferred, only because fresh water is much less abundant and is a premium commodity needed for many other applications. In addition, the most desired water for evaporation would be water that is already devoid of dissolved CO₂. If ˜10¹⁵ kg per year of water, devoid of CO₂, were evaporated, the resulting cold rainwater would thoroughly scrub and sequester Earth's atmosphere of gaseous CO₂ plus many other pollutants. Thus, macro water-evaporation offers additional unexpected bonuses.

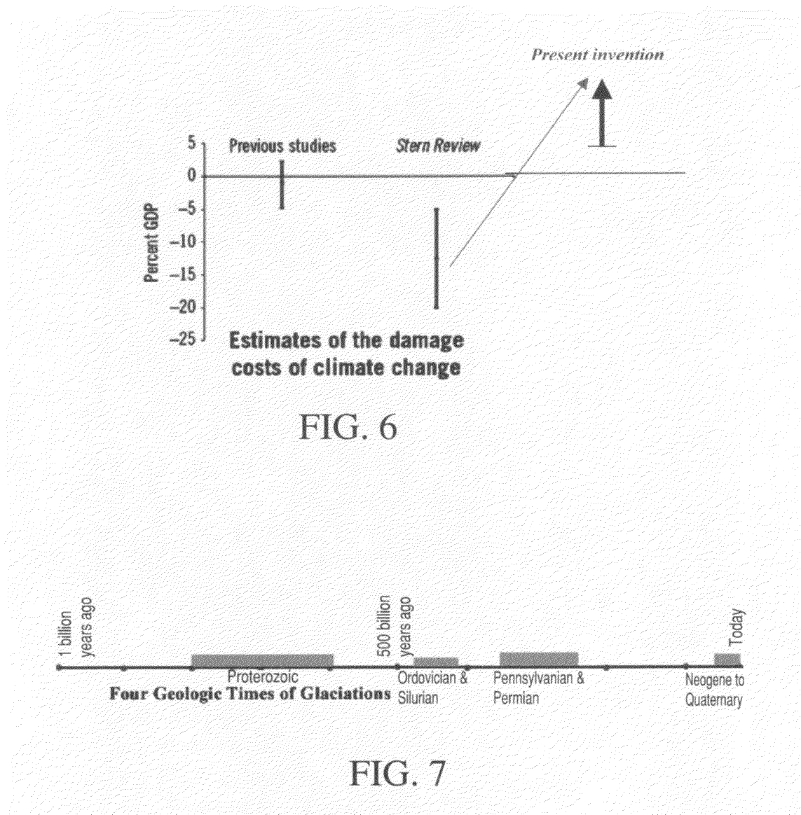

Cost is a paramount issue to global temperature regulation. Previous actuarial estimates (FIG. 6) predict that merely “greenhouse-cooling” Earth by perhaps 0.4 to 0.74° F., will cost mankind many trillions of dollar per year (a large percentage of the global economy). But what if mankind were asked to generate an even more unimaginable “0.6 petawatts” to cool Earth? Assuming a cost of 10 cents per kwh, 0.6 PW would cost mankind a staggering $5,256 trillion. Obviously, $5,256 trillion per year is ludicrous. The present invention proposes to reduce that absurd planetary cooling cost by more than a trillion fold. The present invention proposes to not only cool Earth by a mere 0.74° F., but it proposes to cool Earth about 5 times cooler (˜3.5-4° F.) while costing mankind nothing. In fact, the present invention goes one better and proposes to produce a large net increase in global economic prosperity, the opposite of a net financial burden. No prior art proposals can do that.

The multitude of direct and indirect global economic benefits of the present invention include: 1. extremely inexpensive global space conditioning (when combined with potable-water U.S. Pat. No. 6,688,129); 2. inexpensive, fully reliable, and totally clean, macro solar electricity (due to new macro solar energy storage capabilities); 3. increased global agricultural food production; 4. increased hydroelectric power, and; 5. increased global potable water supplies.

### III. Sequestered Solar Energy. The 3^{rd} Simultaneous Cooling Mechanism

The principal object of the present invention is that of reducing the amount of solar heating on or near the Earth's surface. As illustrated in Section II above, solar reflections by clouds and infrared radiation via vapor-cooling are but two of the three physics mechanisms to cool Earth. The third component of the present invention—sequestration of solar energy—is what powers the above macro evaporators and also makes the present invention most “prosperous”. As will be shown, the process of evaporating macro quantities of water requires macro quantities of costly input energy. It is actually possible to fully and permanently sequester 0.6 PW of incoming solar energy deep underground at very high temperatures and pressures, to cool Earth by about 3.5° F. But permanently “burying” 0.6 PW is not only costly, it is a terrible waste of extremely valuable energy. If a permanent sequestration method has now been found (herein), then a retrieval method is also readily possible (as will be shown). Mankind's thirst for clean energy is unquestionably exponentially growing. Mankind presently consumes about 400 quadrillion BTUs/year, equivalent to about 0.013 PW, which is currently valued at about 10 trillion dollars per year. Thus, sequestering 0.6 PW (46 times all human energy needs) to cool Earth is an overambitious goal. But man's exponential appetite for clean energy is so great that by the time so much solar sequestration is actually achieved, 46 times more demand might also be a perfect match (a $138 trillion dollar match?). Regardless of the match or mismatch, one thing is clear. Sequestering solar energy with retrieval capabilities, represents the pivotal breakthrough to the long overdue “solar energy revolution” or, the “Solar Age”. Sequestration of just a small fraction of the 0.6 PW goal can propel mankind directly into the solar-economy that man has sought for more than 2000 years, while simultaneously powering the thousands of proposed artificial evaporators of the present invention. Thus, if solar sequestration cooling is combined with cloud and infrared cooling, a small portion of the very high temperature sequestered solar energy can be retrieved to more than totally power all of the macro evaporators described herein. In fact, essentially all of mankind's energy needs can be retrieved from sequestered high temperature solar energy while cooling and re-hydrating Earth, while more than paying for the entire ambitious global cooling project.

Section II focused on solar reflectivity and infrared radiation to cool the planet. This section focuses on the third preferred embodiment of the present invention where incident solar energy is first concentrated and absorbed as high temperature heat, and then transported thousands of feet deep into the earth where it can remain at very high pressures, permanently insulated from Earth's surface or, can be retrieved for man's needs, if so desired. The present subterranean solar absorption embodiment exhibits extraordinary economic benefits far beyond the evaporative water embodiments, primarily because very high temperature subterranean energy storage can also be retrieved for distributed space heating, for conventional super critical steam powered electricity generation, water-desalination, and many other extremely valuable uses.

Everyone knows that solar energy is man's greatest source of clean, perpetual, free energy. Unfortunately, there has been one monumental obstacle preventing its adoption as man's prime energy source—the lack of long-term macro solar energy storage . . . months of macro energy storage.

Solar energy continuously heats Earth but is not continuously available 24 hours of each day in any one location, nor is it reliable every day of each year. There are times when the sun is obscured for more than 30 days in many locations. Even if enough solar collectors were provided to meet all of man's energy needs—each night, stored energy or conventional energy sources are required. Full capacity alternative energy sources would have to be built and stay running or on “hot-standby”, at all times, even if solar energy were momentarily blocked by transient clouds. Therefore, even under the very best conditions, solar energy is useful for far less than half of the time. The cost of full capacity standby power plants would still be there. Longevity macro solar energy storage is absolutely essential if low cost solar power is ever to become a prime source.

There are few prior art solar energy storage technologies. None can be economically scaled to macro thermal storage capacity. One of the most popular prior arts is molten salt solar storage at up to about 500° C.—far from adequate to achieve super critical steam turbine efficiencies. However, scaling small molten salt storage from only hours of storage to over 30-days—and preferably months—is not only very difficult, the size of one macro molten salt container to power just one large city would have to be measured in cubic kilometers or cubic miles. The storage cost alone would dwarf the rest of the macro solar collector and generator system. Safety factors of macro molten salts overwhelm the concept. Should such a nearly red hot container ever fail, there could be disastrous local and distant consequences. Thus, molten salts offer only hours, or at most, days of energy storage at prohibitive costs and even higher safety risks. Few, if anyone, consider contained thermal energy a viable option.

Months, not days, of macro thermal energy storage is needed to present ultra dependable service for so many vital applications like space heating and electricity. Cost effective, safe, subterranean macro thermal storage, at any desired macro capacity, is now possible:

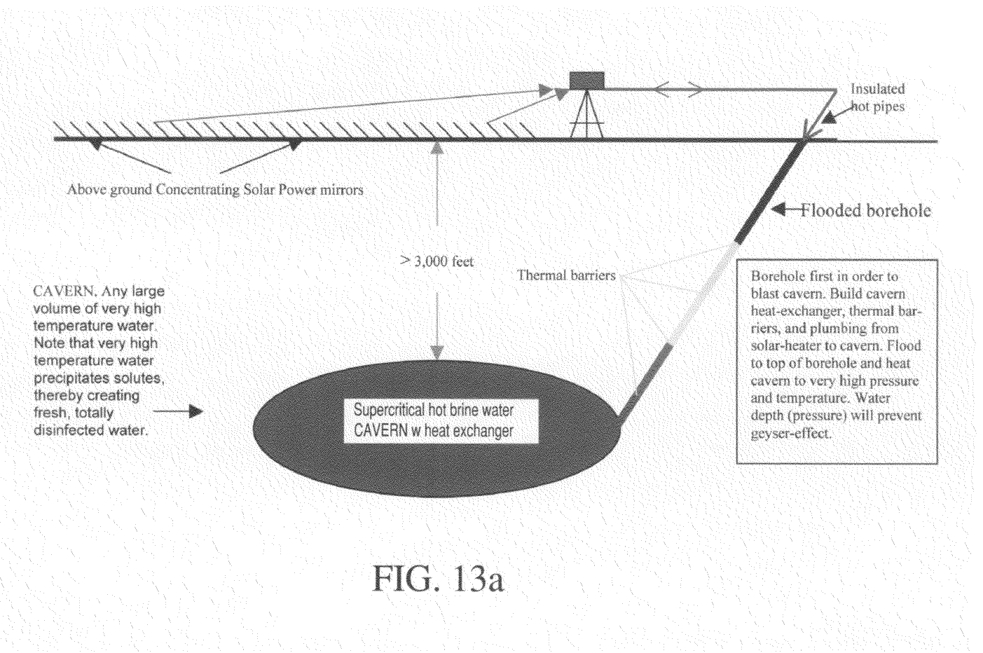

FIG. 13 illustrates a simplified >600° C. subterranean macro solar sequestration installation, which can also dual as a macro storage installation with energy-retrieval capabilities. An array of solar concentrator mirrors is used to produce a >600° C. fluid (gas or liquid), which is pumped deep underground and absorbed by a large volume of earth (or cavern of water) approximately 4,000 or more feet deep. The pressures at these depths (˜4,500 psi) are sufficient to withstand liquid water pressures at about 600° C. (4,500 psi). Therefore, the desired very high temperatures and the unlimited high volume storage can be met with deep subterranean storage. It is also clear that the macro solar energy, which is removed from the surface of Earth, and permanently buried far underground, can fully achieve global surface cooling. This is equivalent to clouds reflecting the solar energy into deep space plus infrared cooling. Thermal energy captured and permanently buried as thermal energy, will not heat the surface where we live. Injecting heat energy into damp rocks, which have seen higher temperatures, is generally not a major obstacle. This concept is one example of the solar absorption embodiment to cool the planet. It is also an example of a reversible energy-retrieval technology. Apparatus to pump energy down deep can also be used to retrieve the energy when run backwards.

FIG. 13 illustrates a method and system for subterranean macro solar (thermal) energy storage. One half cubic mile (7 gigatons of earth) raised to 600° C. (300 bar supercritical water pressure) can store enough thermal energy to power entire very large cities for a year. To permanently sequester (not retrieve) solar energy, the boreholes must be spaced or fanned far apart. The broad invention (not the specific example above) envisions super-heated water stored at depths sufficient to counterbalance very high steam pressures.

FIG. 13a illustrates another solar collection method capable of sequestering enormous solar energy which can be efficiently recovered to power macro evaporator machines anywhere on the planet. This system utilizes ultra low cost very deep supercritical brine water thermal storage at >99% efficiency. Multiple physical “thermal barriers” are required in the borehole to prevent explosive geyser effects. There is no doubt that prior art concentrated solar power (CSP) technology can produce almost any very high fluid-temperature desired (fluids include helium/hydrogen gases). My co-pending patent addresses 99% efficient CSP receivers—the devices which capture and trap CSP solar energy. Effic-ient borehole equipment, capable of boring more than 30-feet diameter holes through rock, is commer-cially available. Cavern blasting and mining technology is old prior art. What are new and essential to the macro storage in FIG. 13 are the plural thermal barriers inside the borehole. After the borehole is excavated and flooded, and the water heated to explosive temperatures, the hot cavern water cannot be allowed to flow by convection upward in the borehole. Convection of supercritical water could become explosive if it rises to sufficiently how head pressures to become a continuous geyser. The entire cavern contents could explode through the borehole. The thermal barriers are any physical wall blocking convection flows every few hundred feet along the borehole length. The barriers do not have to be water-tight to any precision. Barriers can even have holes through them several feet in diameter for easy passage of large water pipes to and from the cavern. Thermal barriers have very small pressures applied to them by convection forces. They merely prevent a cascading eruption.

The thermal losses from such a large subterranean storage volume are surprisingly low, if the thermal storage field is compact. Conversely, if no thermal retrieval is wanted (only permanent sequestration is wanted), the storage field can be fanned out so that the deep thermal losses are maximized. It is well known that rock and earth are not good thermal conductors. It is also well known that thermal losses grow linearly with the outer exposed surface area. However, it is also well known that the volume of a “container” grows by the 3^{rd} power of the diameter, but the surface area only grows by the diameter squared. Thus, if one side of a cubic storage container is enlarged from 10 units to 1000 units, the exposed surface grows by 10,000-fold, but the volume (energy storage matter) grows 1,000,000 fold (100 times the volume to surface area ratio). Thus, the percent energy loss of macro containers can become negligible. Macro-sized computer modeling has revealed that extremely low-percentage losses are possible. Likewise, highly distributed plumbing produces very high thermal losses if permanent sequestration with no energy retrieval is the desired goal (only global cooling).

This solar sequestration embodiment contemplates very high-temperature solar energy several thousand feet deep within the Earth. Such an approach, at first glance, might seem to be both very expensive and impractical. However, it is, by far, the most practical clean and safe solar energy storage means ever proposed. Unparalleled energy densities for entire large cities are now possible with solar sequestration—while simultaneously cooling the Earth's surface. Very high temperature subterranean energy storage offers the ability to retrieve on command, the otherwise troublesome surface solar energy, thereby allowing solar energy to finally become mankind's primary power source—a dream thousands of years old, but never, until now, made practical. One clear objective of this embodiment is complete fossil fuel and nuclear fuel independence, which eliminates all concerns and costs associated with sequestering greenhouse gases, disposing nuclear wastes, and oil/gas exploration. A true “solar economy” is born only if massive long-term solar energy storage becomes practical—just one of the many byproducts of the present planetary cooling invention. Of course, the other byproducts of retrieving some of the sequestered solar energy offer macro-economic benefits, such as extraordinarily low cost space conditioning (detailed within) and unlimited clean electricity. The entire cost to cool the planet can be far more than recovered by generating electricity from retrieved subterranean stored solar energy.

There are at least two ways to retrieve and deliver high-density subterranean stored energy to every person. One energy-delivery method involves delivering electricity, extremely efficiently generated from very high temperature super-critical subterranean thermal storage, and delivered to everyone at the speed of light. Another thermal energy delivery method wisely deploys the world's existing multi trillion dollar potable water infrastructure, as taught in my U.S. Pat. No. 6,688,129—wherein massive amounts of modest temperature energy (¼ of the nation's energy) may be transported to buildings via the existing potable water infrastructure for space heating.

In summary, the present invention contemplates combining reflective cloud-cooling and infrared radiation “vapor cooling” with the latter solar absorption sequestration cooling embodiment, to not merely permanently cool the planet to a stable temperature and preserve our seaports, but to also achieve these lofty goals with macro economic prosperity.

### IV. Prior Art Proposed Global Warming Solutions

There are countless proposals to reduce human greenhouse emissions. Some prior arts focus on manufacturing more efficient power-hungry devices, including more efficient vehicles. Hydrogen economies are frequently proposed, but hydrogen is merely a clean energy carrier, which depends on other prime energy sources. Clean prime energy sources are still lacking. Costly nuclear energy options also abound. Nuclear carries massive disposal and radiation hazards. Solar energy is the relentless and illusive prime energy option, which has almost no chance of becoming a prime source to meet man's needs without affordable macro solar energy storage of this otherwise extremely intermit-tent solar energy. Unlimited solar energy storage has, heretofore, been the missing solar ingredient. The list of proposed energy alternatives to reduce human global warming is very long. However, they all completely ignore the far larger global warming issue—natural global warming, which is an issue at least 5 times greater than human global warming. Natural global warming has melted most the ice on Earth many times before, and it is accelerating now as the ice dwindles. It is the far larger natural warming phenomenon that must solved, as well as the smaller human greenhouse factors.

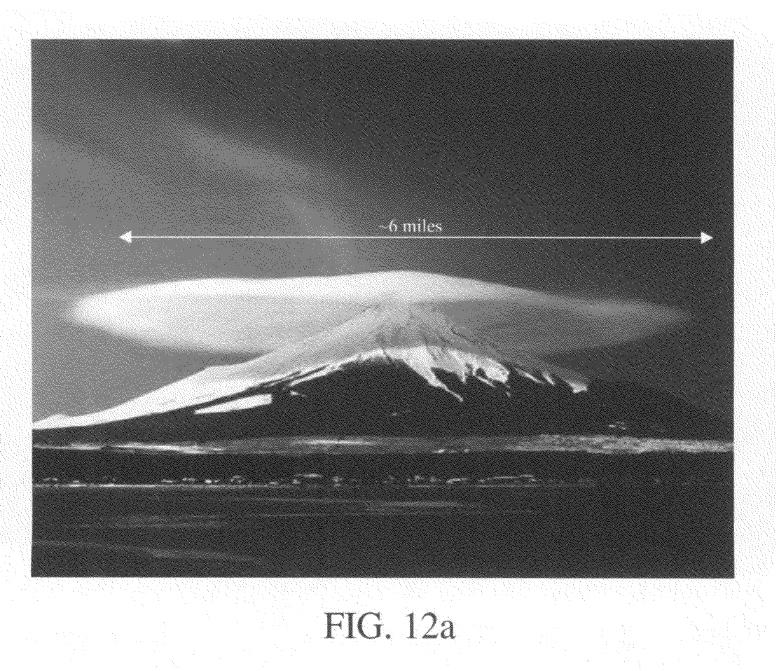

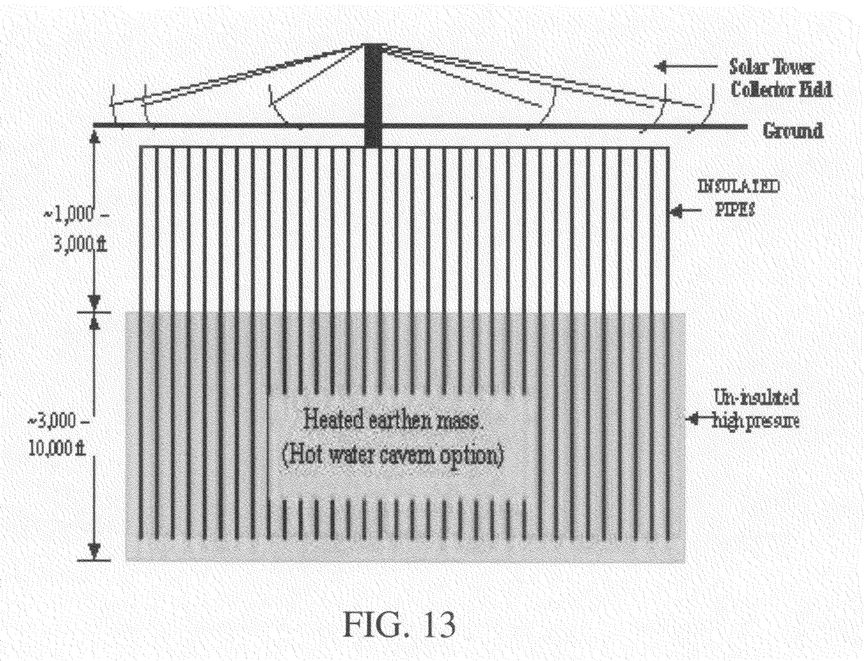

One prior art very low altitude artificial fogging (clouds) proposal by John Latham and Stephan Salter (see Latham and Stephen very low level fog generating vessels at http://news.bbc.co.uk/2/hi/programmes/6354759.stm) involves about “50 m³” of sea water per second (1.6×10¹² kg per year) aerosoled just feet above the oceans from about “1000 200-ton” seaworthy vessels aimed at reflecting about “3%” more solar energy into space. Ground level fog reflects no solar energy when shadowed by natural high altitude clouds. Conversely, the present invention radically differs by proposing almost instantaneous aerosol evaporation in dry air, resulting in high altitude cloud formations to take full advantage of solar reflections plus very powerful infrared radiative cooling. Referring to FIG. 12, “3% more reflection” by low altitude clouds would raise Earth's reflection from the present 30% to about 31% (0.89 PW). Unfortunately, the fog vessel technology appears to contain grossly flawed assumptions.

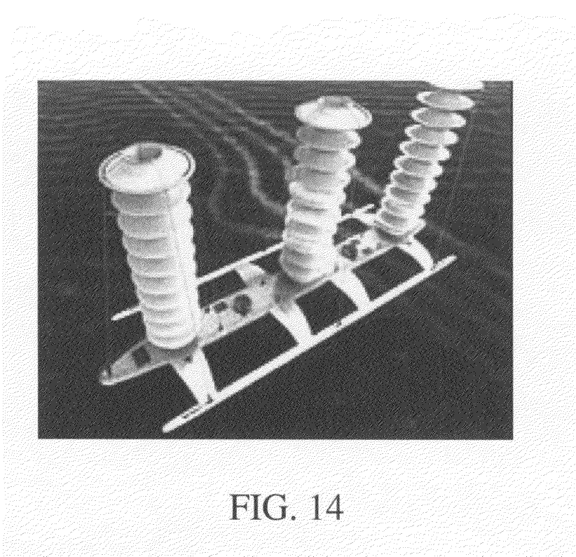

The proposed ground level fog generation from fragile vessels is graphically illustrated in FIG. 14, wherein. “a thousand” seaworthy vessels are proposed to create very low altitude clouds to reflect solar energy into space. Aside from the fragility of such tall vessels against even modest winds, dangerous navigation to all sea vessels would result from fog-impairment. Greatly enlarged pontoons for durability against storms, would subject the vessels to ocean wave destruction and still fail to correct mere human global warming, not the much larger natural global warming problem. This prior art confirms the generally accepted properties of clouds reported by others, but fails to approach the far superior “macro” performance of the present invention in several ways. Grossly incorrect aerosol longevity assumptions (orders of magnitude errors), as well as other incorrect mathematical assumptions in ground-fog generation, incorrectly conclude that only about 12 gallons per second per ship can cool the entire planet. Moreover, unlike the present invention, ground fog aerosolation of a mere 50 m³/second produces imperceptible vapor cooling and insignificant infrared global cooling. The proposed high center of gravity ships cannot sustain even modest winds or ocean waves without capsizing. All the above (and other errors) make the low level fog proposal woefully inadequate to reverse mere human global warming, much less the far greater natural global warming objective of the present “gigaton” macro evaporation invention. Furthermore, massive oceanic fog would impair low altitude aircraft and especially sea navigation, leading to potential sea catastrophes. The present invention is radically different, can meet the objectives, and creates no such impairments.

Other prior art suggests orbiting megaton mirrors to reduce global warming. This novel approach has many serious drawbacks. Aside from the high cost (˜20 trillion) of orbiting millions of square meters of micron-thin mirrors (or one extremely large megaton mirror³), the task is mind-boggling and beyond known space technology. Placing billions of uncontrolled tiny mirrors in orbit, could impact nightlife on the planet in ways that no one can predict. Day and night sky visual appearances would forever be altered and would also not be reversible. Long-term animal and plant life responses to mirrors are unknown. Visual and radio space telescopes would be impaired. The “not reversible” aspect of mirrors is just one dangerous aspect. Should unforeseen natural cooling take place on Earth, orbiting mirrors cannot be easily removed and excessive planetary cooling would be disastrous. Everything placed in orbit eventually falls to earth (usually just a few years) or, in the case of one large thin mirror closer to the sun, rapidly decays. Thus, orbiting mirrors must be frequently replaced at full cost as the old ones fall or decay. Inter-governmental cooperation is highly unlikely, given all the potential dangers and extreme costs of orbiting mirrors (or orbiting sun shades).

Various atmospheric chemical seeding proposals exist. Most are directed at reflecting portions of solar spectrum from earth—with almost no infrared radiation benefits or vapor cooling. Here, like orbiting mirrors, the process is inherently very dangerous. No one can say, with the slightest certainty that countless plant, animal, and essential microbial life forms, would be safe from even a one-time-seeding of megatons of the most benign chemical/s. And the latter does not even begin to consider very long term exposures to almost completely undocumented and unstudied bio-chemical interactions. This class of global warming solutions is highly discouraged by most scientists. This sort of poorly conceived and even desperate “science” has generated disrespect for the term “geo engineering”.

Parenthetically, the solar reflection embodiment of the present invention technically proposes “atmospheric chemical seeding” but with the completely non-toxic chemical called “water”—that material upon which all life depends. Macro “water seeding” can be quickly stopped, as well.

### V. The Existing Global Potable Water Infrastructure For Huge Energy-Delivery

Lying just a few feet directly below all of us is an existing multi trillion dollar potable water delivery infrastructure, which, according to U.S. Pat. No. 6,688,129, can be used to simultaneously deliver water PLUS copious thermal energy to everyone. Space-conditioning energy consumption is not trivial. It represents ⅓ to ¼ of mankind's total energy needs. Since one embodiment of the present invention includes the abilities to store and retrieve macro quantities of either “cold energy” or “hot energy”—a thermal energy-delivery system would be very welcome indeed. Patent '129 offers that opportunity.

A brief description of patent '129 is helpful in marrying these two innovations. Patent '129 deploys a small potable water tank (typically 50-200 gallons) thermally connected to a small heat pump wherein potable water can be endlessly re-used to exchange 58° F. ground-heat to buildings very efficiently. Potable tank-water is frequently exchanged with the underground water infrastructure in order to supply enough thermal energy to space condition entire buildings. But patent '129 also observes that perfectly clean waste heat or waste cold energy can also be introduced, by potable water purveyors, into the drinking water system. Such waste (or stored) thermal energy would make the space conditioning heat pumps of '129 many times more efficient. For example, if potable water were first chilled (from some free source of “cold energy”), such ice cold potable water could space-cool entire buildings without even a need for a heat pump (zero electricity). Likewise, if potable water were mildly pre-warmed by any free waste heat source, the pre-warmed (perhaps 80° F.) potable water could heat entire buildings with the assistance of a very small, very low powered, heat pump.

The above potable water energy delivery concepts in '129 can be expanded to macro energy storage systems contemplated by the present invention, which are detailed in this document. For illustrative purposes, assume there exists a totally free, hypothetical macro thermal energy storage system in the vicinity (within many miles) of a potable water purveyor facility. If an unlimited macro energy storage facility were provided to a potable water purveyor, a modified version of patent '129 could deliver the stored thermal energy to everyone, as follows.

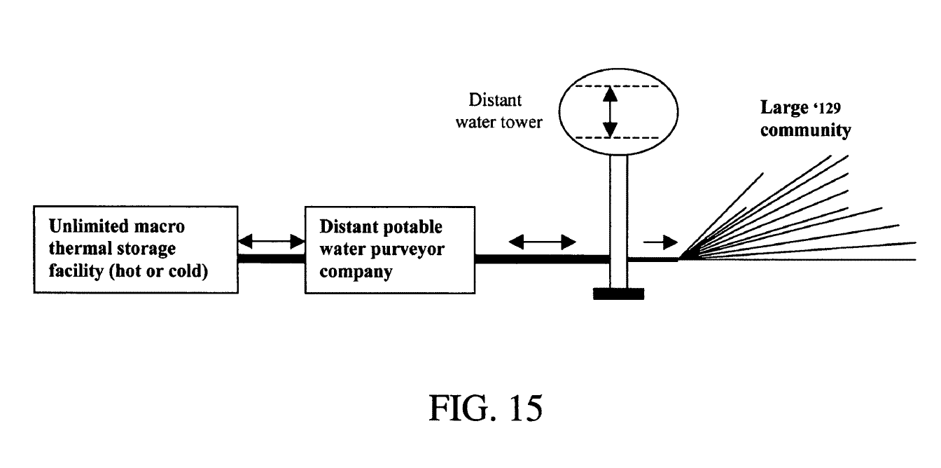

FIG. 15 depicts a water purveyor and one water tower supplying constant pressure water to a large number of potable water customers. In summer months, the water tower is filled and maintained with ice-cold water, which patent '129 uses for extremely low cost space cooling. But the water tower has only limited volumetric capacity—far too little thermal BTU capacity to continuously space-cool all the buildings that it serves. Water purveyors can very cost-effectively cause tower waters to periodically gravity-flow-back to the water supplier, followed each time by pumping fresh ice-cold water back to the water tower. Thus, one water tower, with very limited capacity, would perform as if it had perhaps 50 or more times its actual volumetric thermal capacity—enough thermal capacity to supply an entire community with extremely low cost space cooling. Without detailing a winter scenario, the same concepts just described, apply to modestly pre-warmed tower water. Thermal losses within such massive un-insulated water towers are surprisingly small. Likewise, the pumping energy to and from water towers is negligible compared to the value of the thermal energy within the water. And finally, the plumbing-thermal-losses during pumping of either cold or warm water to and from water towers, are also surprisingly small. In conclusion, large water towers can be transformed into jumbo thermal energy delivery hubs for large communities that employ the teachings of patent '129.

One more modification to patent '129 allows very cold or pre-warmed potable water to arrive even at the most distant potable water customer locations. Referring once more to FIG. 15, note that the water in the tower is maintained at the desired warm or cold temperature, depending on the season. One water tower performs like a 50-500 times larger constant temperature delivery hub. Very similar to the thermal capacity enhancement of water towers discussed above, so too are there thermal enhancements possible in getting enough pre-conditioned water to flow to many small water tanks located at water-customer locations. Without this modification to '129, only the first water customers nearest the water tower would receive the pre-warmed or pre-cooled water. As each water customer extracted the thermal value from the water, the customers progressively downstream would receive less and less of the pre-conditioned thermal value. There simply is not enough water-flow in the pipes, especially at night, when little potable water is consumed. To overcome that limitation, patent '129 can be modified to make the water mains appear to have many times more flow capacity without altering the water infrastructure and without actually wasting any water. For brevity purposes, suppose one entire '129 community illustrated in FIG. 15 were precisely timed to simultaneously pump their water contained in their small on-site potable water tanks, back to the constant-temperature water tower. In such a case, the water tower level would rise slightly. Moments later, all of the small holding tanks downstream in that community, can be re-filled by gravity—this time however, all of them, including the most distant small '129 tanks, would fill with fresh pre-warmed or pre-cooled water from the water tower. Thus, an entire community would continuously have full access to a constant supply of pre-warmed/pre-cooled water even in the dead of night if there were no potable water consumption. There is a simple way to precisely and permanently time everything to a small fraction of a second absolute accuracy. There is in place a worldwide very low frequency (VLF) radio time-standard transmitter system, which is accurate to a small fraction of a second. Each '129 installation can include such an accurate and very inexpensive time clock chip (similar to the inexpensive consumer “atomic wall clock” chips). Thus, when it is “time” to simultaneously pump potable water back to the tower, an entire community (preferably, only a section of a larger community) can start pumping at nearly the same time. This improvement to '129 is called the “Time Wave”©. There are a variety of timing sequences possible once a precise time standard chip is incorporated. However, the “Time Wave”© is totally equivalent to one massive water pump purging all of the water mains all the way back to the water tower, at no pumping cost to the water company. End users pay their own very small, intermittent, reverse pumping electric bills.

No new patent applications for either the “Time Wave”© or the constant temperature water-tower enhancements are warranted. Patent '129 covers the subject very thoroughly. None of the previous thermal enhancements are useful without the teachings of patent '129. It is important to emphasize the enormous energy reductions and the financial benefits to end-users for ultra inexpensive heating, cooling, and hot water. Water companies, and regulatory overseers of water companies have a rare opportunity to share in ¼ to ⅓ of the nation's entire energy industry . . . thereby offering States and, for that matter, nations, an opportunity to fund national budgets from massive energy savings.

In summary, ¼ to ⅓ of mankind's energy needs (˜400 quads) can be met with the present invention's hot or cold macro thermal storage, when combined with potable water energy-delivery patent '129. Macro high temperature solar storage can also be used to generate macro cold energy storage. This technological combination offers space-conditioning savings in the range of trillions of dollars. Such dramatic space conditioning energy savings represents enough greenhouse emission reduction to prosperously solve the human component of the global warming goal. The positive economic impacts are so great from this one application that all the other much larger natural global warming issues can be readily afforded from a tiny fraction of the space conditioning energy savings. But, as previously stated, macro thermal energy storage technology offers far more than just very low cost space conditioning. All of the world's electric power can be generated from high temperature macro solar energy storage too. The combined economic impacts far exceed the space conditioning impacts. All of the economic impacts are summarized in the conclusions.

### VI. It's All About Water

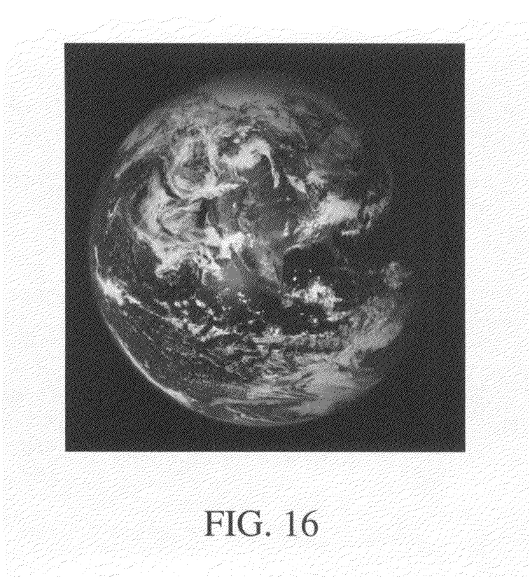

With a fresh and unbiased mind, take one more look at mother Earth and describe exactly what you see, as if seen for the very first time. FIG. 16 illustrates our sphere covered mostly by water and to a lesser extent—land overrun with plant life. Condensed water vapor clouds punctuate the atmosphere and ice accentuates both poles. In other words, water dominates the oceans, the land, the poles, and even the plants. A closer investigation shows that the total exposed surface area of Earth is dominated not by oceans or land, but is overwhelmed by the total surface area of transpiring plant-leaves in contact with the atmosphere, for tree/plant leaves readily exceed ˜10¹⁵ m² vs 3.6×10¹⁴m² for oceans.

Therefore, as FIG. 16 Illustrates, it is all about water evaporation—plus the slow, persistent struggle of large surface area plants to occupy Earth and transpire water. Greenland and the Sahara were fully enveloped more than once with large plant life. Even the Antarctic is not immune to invasion by transpiring plants. Too few plants are surely detrimental. It now appears that too many can be equally detrimental and that it is possible that too many clouds every 100,000 years can aid in creating an ice age.

Ockham's Razor, (14^{th} century) (see http://en.wikipedia.org/wiki/Occam%27s razor) recommends always seeking the simplest explanation of cause and effects. In that light, let us actually apply this wisdom to observe Earth as if for the first time. Earth's total surface area is roughly 25% land and 75% oceans. However, the surface area of all the plants (especially their leaves) far exceeds that of the oceans. If plants inhabited the many deserts and glacial lands, as they have in the past, they would hugely impact Earth's hydrological cycle.

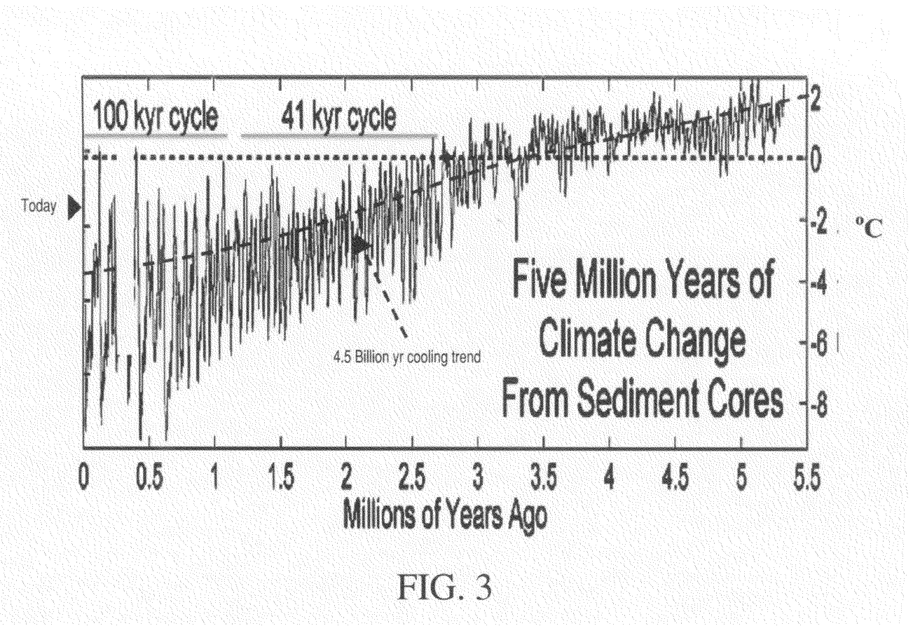

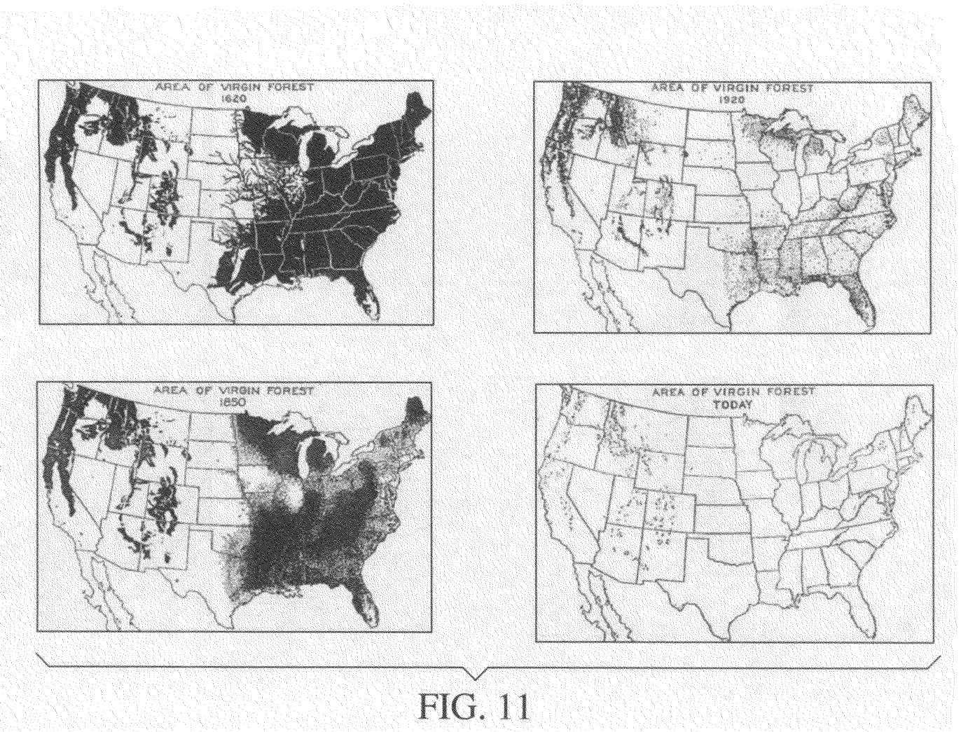

Theoretically, Earth can support >300 billion very large trees spaced approximately 50-100 feet apart from northern Greenland to Antarctica. Such trees, which can uniquely reach into the upper aquifers (Earth's second largest body of water) might have once transpired up to 150×10¹⁵ kg of water per year into the atmosphere—considerably more than shown in FIG. 10. The intriguing question about large trees is this: Was there once ˜200 billion more large trees prior to Earth's present dehydration? If so, Earth would be more humid and have much higher cloud coverage. If so, Earth would be in a cooling stage and the resulting new glaciers would start cascading equatorially to macro-deforest them again, as has happened many times before. Are the macro over-population and deforestation events the triggers or the explanations of numerous natural warming and ice ages? No one is certain. Numerically, it's quite plausible. More geologic research is needed. However, large scientific bodies are ignoring the hydrologic cycles and have focused on “human greenhouse gases”. But as vividly illustrated in FIG. 3, the brief 150,000-year human inhabitation cannot explain millions of years of cyclic natural global warming and many ice ages. Greenhouse gas concentrations have been more than 10 times higher than today long before Man—and that coincided with Earth's coldest period.

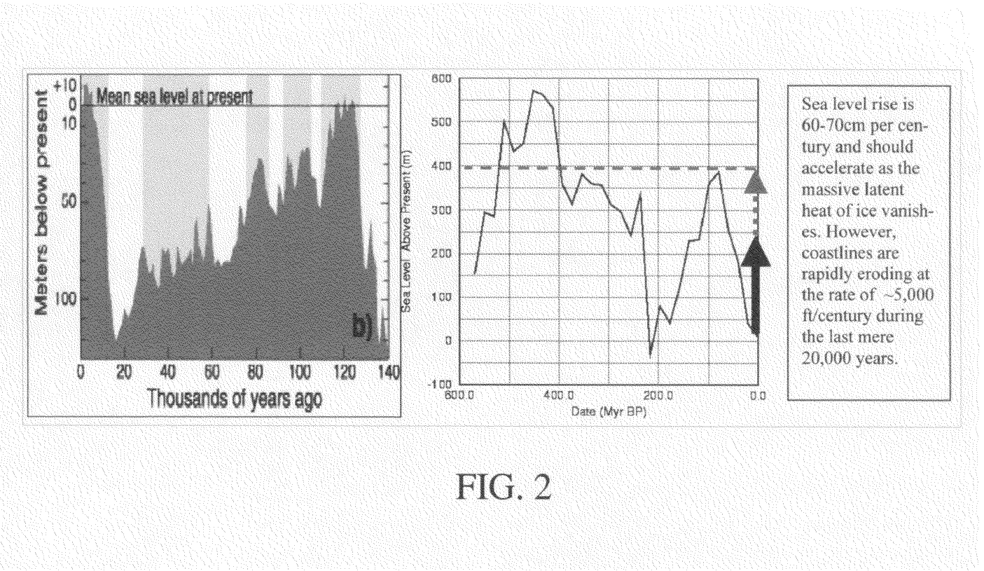

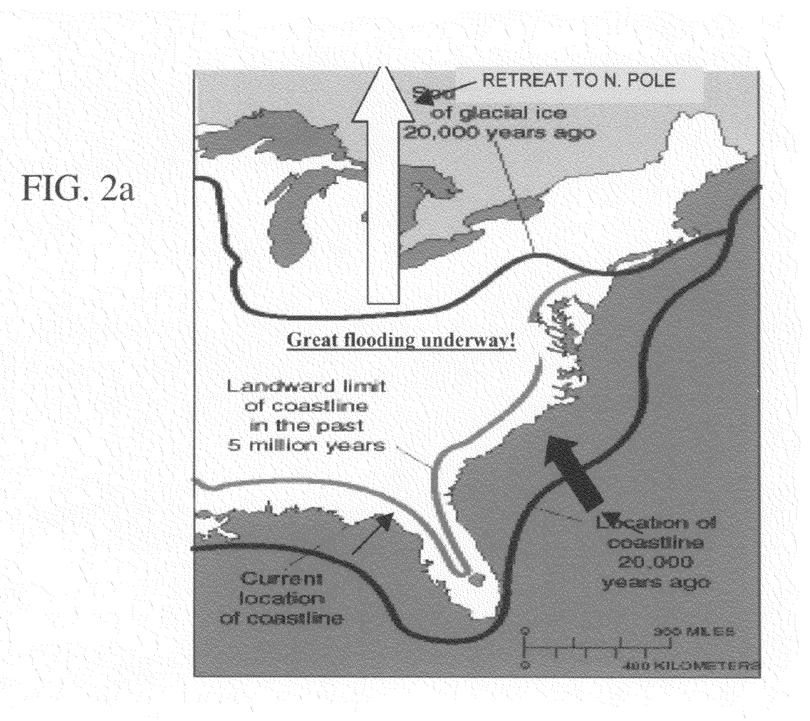

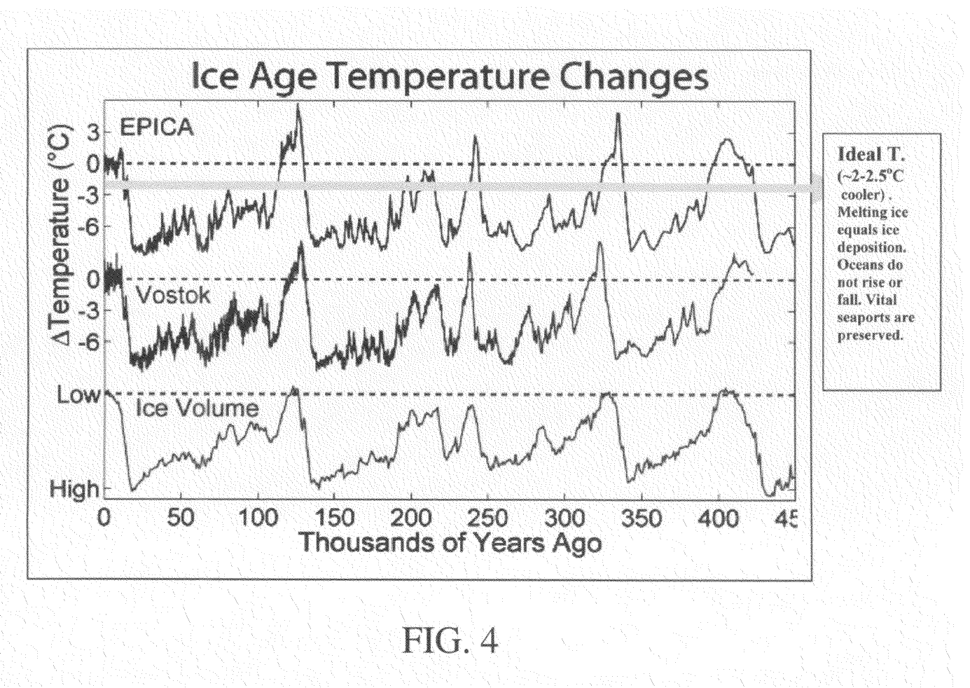

It is not critical to know for sure that natural deforestation can be, or has been, responsible for nat-ureal cyclic global warming. The critical factual knowledge is that Earth is presently very warm (FIG. 4) and that we dare not lose our present glaciation, our coastlines (FIG. 2a), and our vital seaports.

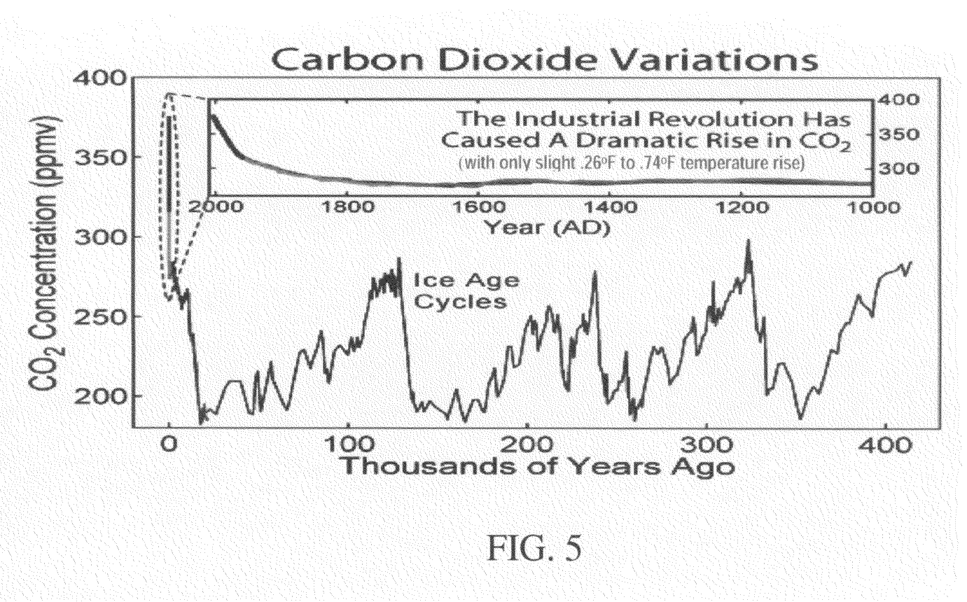

Nonetheless, by simply asking questions about big trees suggests potentially pivotal discoveries about our future. For example, man is deforesting. But does nature deforest far more than man? The answer to the second question is also a resounding yes. Natural deforestation far exceeds mankind's, and has done so repeatedly many times long before mankind. Man is adding to deforestation and will likely continue to do so. Wood is a wonderful material. And if the above is true, can the present “cooling invention” really substitute trees as a “permanent thermostatic solution?” The question has been addressed in previous sections. The present invention can gently—as well as selectively—re-humidify Earth. Ironically, the calculated amount of artificial re-humidification lies in the same realm of de-humidification as the calculated hypothetical missing big trees. Moreover, if the bulk of missing big trees were non-equatorial big trees, then the clouds that they might have produced long before deforestation would be longevity clouds—the longevity clouds which cool Earth the most. Thus, with so many missing clouds today, Earth would naturally heat—as we see in FIGS. 3, 4, and 5. Therefore, as human deforestation continues, the present invention becomes even more vital to thermostatically and hydrologically stabilize Earth.

It is emphasized that no known previous research has confirmed the paleo relationship of big tree populations versus Earth's thermostatic cycling. Ancient big-tree artifacts have not been classified that well. More ice age research might confirm the relationships. One can speculate forever about geological shifts of water tables as continents rise, fall, quake and drift. One can speculate about “100,000 year droughts”, volcanic discharges, plant blights, macro forest fires leading to dust and sand dunes which propagate deserts, glacial deforestation, and perhaps dozens of other mass kill-off mechanisms. The answer is simply, “we are not certain”. However, we do know that big trees uniquely reach into the massive 15,300×10¹⁵ kg underground fresh water aquifers (FIG. 10) and that Earth is definitely experiencing over-heating and desertification. All of this is worthy of much more tree research. The end result does not change the critical need today. We must halt glacial melting.

What can be concluded from the above estimations and speculations is this: If mankind continues to deforest, we definitely need macro artificial humidification. Our food and water supplies are at stake. A dehumidified Earth definitely causes solar-heating as a result of slightly fewer clouds. And, if mankind expects to continue his present exponential population growth, global climate regulation is essential. Man needs a permanent macro cooling technology, not an emergency heating technology. And, if future man must continue to regulate during what appears to be a permanent overheating condition, then man will always have the ability to slow down his cooling machinery to preserve the ideal conditions. That would not be true if Earth were too cold and required heating. Thus, the present invention is only useful as a cooling technology—not a heating technology. Earth can be thermostatically regulated only if we are being overheated. Deforestation is just one cause of over-heating. Other Earth-orbital, precessional rotation, and solar anomaly over-heating causes exist. The present cooling invention applies to all overheating causes.

### VII. Inviolate Physics of Water-Aerosolation

Aerosoling water into tiny droplets with great surface area for rapid evaporation comes at a price in energy. There are no free rides in physics. The inviolate laws of physics in creating small aerosol droplets are well defined. The absolute theoretical minimum energy required to divide liquid water into smaller droplets is governed by the surface tension of water and the total surface area produced. Any additional input energy is merely a result of device inefficiencies. “Impact” aerosol technology offers very high efficiencies. The surface tension of water is 0.07275 joule/m² (0.017376 calorie/m²) at 20° C. (68° F.). Thus, the smaller the droplet size and the higher the final surface area, the higher the minimum input energy, regardless of the means to achieve the end result. Thus, the theoretical minimum input power required to aerosol water, is simply the input energy per unit of time (E/t).

For example, the theoretical minimum input energy required to aerosol 1 kg of water (one liter) into 100-micron diameter (0.0039 inch) droplets, having a total surface area of 607.6 m², equates to 44.2 joules. And if done in one second, the theoretical minimum input power to aerosol one liter of water would be 44.2 watts. If scaled to macro global proportions such as 10¹⁵ kg/year, the theoretical minimum input energy would be [44.2 j/kg×10¹⁵ kg/year] or, 44.2×10¹⁵ j/yr. And, the corresponding theoretical minimum power required to aerosol 10¹⁵ kg/yr would be only 1.4 gigawatts. Actual aerosol-device inefficiencies will increase the theoretical minimums accordingly. Higher water temperatures will decrease the theoretical minimum input energy to aerosol water.

The above example to aerosol 10¹⁵ kg/yr also illustrates an unprecedented energy multiplier. The theoretical minimum thermal energy, which must be extracted from the atmosphere to evaporate (phase-change) that much water, is 540 cal/gram or, 2,261,000 joules/kg. Thus, the aerosol-to-evaporation energy ratio is (2,261,000 j/kg)/(44.2 j/kg)=51,154. In other words, the theoretical cooling effect is 51,154 times greater than the theoretical minimum input aerosol energy. In space-cooling-terms, this is comparable to Coefficient of Performance or, “COP”. [A typical window air conditioner operates with a COP of about “3”]. A theoretical COP of over 51,000 is an amazing thermal performance. However, the object of the present invention is to not only approach these extraordinarily high 51,000 COP values, but to actually far exceed them, with the added joule-cooling effects of solar energy reflected by longevity clouds. Hypothetically, if one kg of water were to form one 10 m² cloud which persisted for 10 hours, and it reflected just 50% of the incoming 1,366 W/m² solar energy, such a cloud would reject 6,830 j/sec×36,000 seconds or, 2,460,000 additional joules of solar heat. In this hypothetical example, the total input energy would only be 44.2 joules but the combined cooling would be 2,261,000 j of latent heat cooling plus another 2,460,000 joules of solar heat reflection or, 4,721,000 joules of cooling . . . a hypothetical 106,809 cooling-energy-multiplier! In other words, in this theoretical example, the input power to remove 0.6 petawatts (600,000 gigawatts) of solar heat is only 6 gigawatts (comparable to one medium sized city) to theoretically cool the entire planet—not just human global warming but the far greater natural warming as well.

The above hypothetical vapor cooling examples, assumed that the aerosolation input energy was supplied by conventional fossil or nuclear sources. If the aerosolation input energy is solar powered, then the planetary cooling multiplier would be far far greater than “100,000”.

Parenthetically, instead of deploying vapor cooling and reflective cloud-cooling, if the subterranean cooling embodiment of the present invention were deployed, the efficiency of thermal sequestration would be governed only by the small input energy required to pump the collected solar heat underground through a heat exchange loop. The pumped loop input energy can be proportionally reduced by circulating the highest possible temperature fluids underground.

### VIII. Aerosol Timing And Spatial Mobility Produce Surprising Results

Earth's orbit and rotation presents an option to locate and time macro evaporators for maximum effectiveness. Seasons and weather also change the ideal operating conditions, and brief unfavorable dew points can render macro evaporators ineffective. Although some locations, like deserts, present very desirable evaporation conditions most of the time, it is undesirable to concentrate many macro evaporators in one place, which can create undesirable local weather patterns and weather-fronts. Moreover, some of the most desirable desert locations, from a dew point perspective, do not have copious amounts of nearby water to evaporate without depleting or damaging the local environment. Seawater evaporation is preferred for that reason. Macro evaporation offers little to no solar reflection value if artificial cloud formations occur during the night with no sunlight to reflect. Therefore, it is clear that for maximum effectiveness, macro evaporation must be both strategically located around the planet at many desirable fixed locations, that they must be turned off at times when humidity and temperature conditions are not conducive to macro evaporation, and better-still, a portion of the macro evaporators can be an armada of mobile systems onboard sea-worthy vessels in order to take full advantage of the seasons in both hemispheres. Mobile oceanic macro evaporators have several other advantages such as full access to unlimited water for evaporation, optimized evaporation during each season, and access to vast planetary surface area (oceans) without interference with populations or sovereignties. Mobile seaworthy vessels do not require high power propulsion because they only have to be relocated a few thousand miles per 183 days (perhaps 1 mile per hour). Even old maritime technology, such as natural ocean currents and windsailing technology are appropriate for relocating seaworthy mobile evaporator platforms.

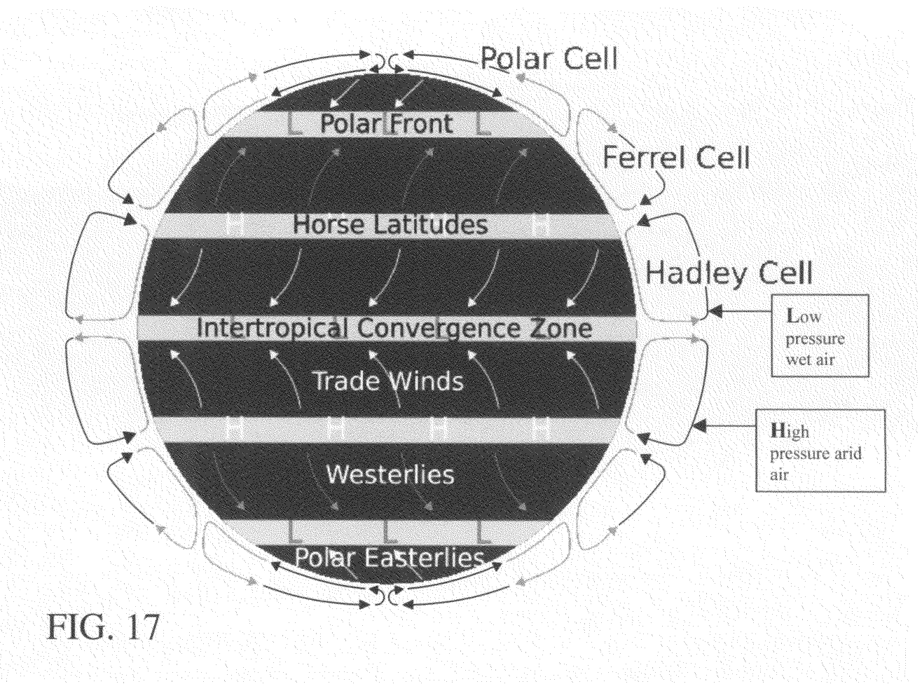

Mostly, fixed macro evaporators are needed. There are a large number of sparsely or unpopulated large islands off the shores of Africa, the Americas, Australia, and even in the middle of oceans and seas, which are suitable for a fleet of unusually large (many tens of miles long) fixed macro evaporators. FIG. 17 illustrates the major air circulation patterns, which can also be employed for maximum cloud longevities for both mobile and fixed macro evaporators. Particularly, the 2 Ferrel Cells. The combination of both fixed and mobile macro evaporators sets the stage to establish thousands of macro evaporators to uniformly re-hydrate Earth and to more-evenly populate longevity-clouds to reflect solar energy. Such temporal and spatial evaporation not only maximizes the cooling of Earth but can do so while imposing negligible impacts on local environments or populations.

Winter macro artificial evaporation, and even polar evaporation, is also desirable. Cold water evaporation in the currently arid northern and southern Ferrel Cells [FIG. 17], offers several surprising macro benefits. For example, if cold aerosoled water [e.g. 33° F.] is evaporated, only a small fraction of water volume can be liberated before liquid water aerosol droplets freeze as ice. But the small volume that is vaporized (still at 540 cal/gram) also liberates 80 additional calories of heat per gram in the phase change to solid water (polar snow). In other words, 640 cal/gram total heat energy is absorbed from the environment and is trapped as fallen snow near the north or south poles. Thus, great planetary cooling effects during winter seasons might appear to be undesirable or ineffective at first glance. However, the exact opposite is true. Artificial water evaporation in the Ferrel Cells can simulate the massive plant transpiration, which took place prior to 20,000 years ago when an over-abundance of greenery inhabited Greenland, northern Europe, (and presumably, the entire Ferrel Cell regions of Earth, including much of America, Canada, Europe, Russia, and China). Such over-abundance of greenery, for perhaps tens of thousands years, could explain the massive buildup of polar ice to miles deep and the resulting cascade of mountainous glaciers flowing toward the equator every 100,000 years (ice ages every 100,000 years in FIGS. 3 and 4). In other words, the truly dramatic changes of water transpiration (many times more water evaporated in the currently barren Ferrel Cell zones), might actually account for and explain our recurrent ice ages and 100,000 year recurrent global flooding. It's reasonable to imagine excessive polar glaciation (from an over-abundance of Ferrel Cell trees and greenery) might produce slow flowing mountains of polar glacial flows toward the equator (at a few hundred feet per year for thousands of years), and in so doing, mow down Ferrel Cell greenery every 100,000 years. Therefore, artificially stabilizing ice formation at the poles can be most profoundly effected by artificially evaporating up to about 5×10¹⁵ kg of water per year in the warmest parts (−30° N and 30° S) of both and Ferrel Cell atmospheres—not the much greener, low-pressure, Hadley Cell rain forests. Greenery is almost always abundant near the equator. Only the Ferrel Cells experience truly profound natural transpiration changes of up to about ˜5×10¹⁵ kg every 100,000 years—matching the 100,000 year ice ages. The present invention can artificially substitute and regulate the profound absence of Farrel Cell tree transpiration. The high latitudes of both Farrel Cells are presently occupied by spindly trees, tundra, and very and land—producing small transpiration. The melting polar ice is not being replenished with enough snow—like the reduced Mount Kilimanjaro snow. The Ferrel Cells are a natural conveyor belt for surface evaporation at low and warm latitudes to transport water (clouds) and water vapor pole-ward. If more water is introduced into the polar atmospheric air cells, and deposit more snow, thermal sequestration (in the form of permanent ice) offers additional solar reflection from the additional snow, plus sequestration of 80 additional calories per gram of thermal energy, not to mention, the gradual lowing of oceanic levels. In addition, low latitude Ferrel Cell evaporation should slightly reduce the fearful ferocious nature (almost hurricane proportions) in northern oceanic navigation.

However, beyond polar ice stabilization (storage), ice formation, and ice storage during winter months in more southern climates, using aerosoled water techniques, has other great commercial air conditioning values outside of correcting and stabilizing global warming, as explained in section IX below.

FIG. 17 illustrates macroscopic atmospheric circulation—the large-scale global movement of air by which water vapor is transported around the planet. The Ferrel Cell, or violent mixing cell, transports great volumes of water/snow to the poles. Artificial macro evaporators can take advantage of these trade winds to produce longevity clouds, particularly near deserts and in the Ferrel Cell.

### IX. Stationary Fresh Water Reservoir-Evaporators And Energy Storage

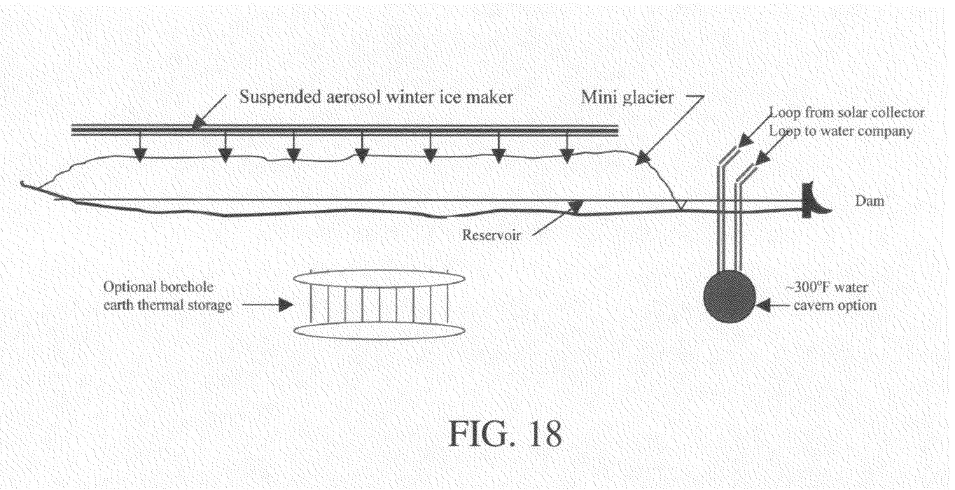

If the land surrounding a typical potable water reservoir (depicted in FIG. 18) is used to store a mini glacier of aerosoled ice (snow generated only in winter months), many reservoirs can be made to store several times more water than they were designed to hold. Compact ice can be extremely economically produced and be stored hundreds of feet thick beside, on top of, or in the reservoir water during winter months. Such massive bodies of ice can be called “mini manmade glaciers”. Such mega-ton massive “mini glaciers” of fresh water contain an extraordinary energy density, considering the 80 cal/gm latent phase change energy of ice. A mini glacier represents so much stored “cold energy” that only a small fraction of it would naturally melt even during summer months. The treasure of stored energy can also be covered with a thin protective sheet of plastic to further reduce summer melting. Therefore, an ice cold reservoir of fresh drinking water can serve as an extraordinary low cost macro storage vessel of enormous summer space conditioning energy to be transported to buildings during summer months, using U.S. Pat. No. 6,688,129 as described in section V (page 17). A typical reservoir energy storage calculation will leave an indelible impression.

Suppose a typical small reservoir measured 2000 feet wide and 6 miles long. The protected watershed (total land surrounding the reservoir) might be 6000 feet wide and 8 miles long. Using a hypothetical man made “mini glacier” dimension of 50 m high by 2000 m wide and 8000 m (5 miles) long, the reservoir would store roughly 800,000,000 m³ of “compact snow” or, roughly 250 million m³ of water (66 billion gallons or 2.5×10¹⁴ cc) of highly energetic cold freshwater. Such a hypothetical 30 feet deep reservoir would ordinarily hold only 15 billion gallons. Therefore, the “mini glacier” described above can increase the effective reservoir capacity to about 4 times larger without additional excavation or damming. However, the stored macro energy in the mini glacier is much more impressive. 66 million gallons (2.5×10¹⁴ cc) of ice stores more than 8×10¹⁶ joules just in the form of phase-change cold energy—that energy involved in just melting 32° F. ice to 32° F. liquid water. There's 8% more stored “cold energy” in the melted water (if allowed to heat to 50° F. (+10° C.) warmer). Even if 50% of the mini glacier were allowed to melt and be totally wasted during a 6 month summer melt, about 4×10¹⁶ j (4×10¹³ BTUs) of “cold energy” can still be delivered for '129 space cooling. If an average home consumed an average of ˜20,000 BTU/hr during a hot 90 day summer (4.2 million total BTUs/home), one “mini glacier” in one typical reservoir can service (4.1×10¹³ BTUs)/(4.2×10⁷ BTUs) or, 976,000 homes. The commercial value of 66 billion additional gallons of stored potable water is significant (˜$90 million), but the value of 4×10¹³ BTUs of summer space conditioning for 976,000 homes (˜$500 million) dwarfs the value of the additional potable water. And this example assumed that 50% of the ice was allowed to melt with no protective plastic cover. The actual BTU value of this mini glacier, in a typical reservoir is so valuable that a minimal thin cover can add hundreds of millions of dollars more value to potential summer space conditioning large communities.

The above space cooling example can be readily scaled to much smaller or much larger reservoirs.

Of course, the “mini glaciers” concept requires that reservoirs have ample real estate to store ice, precautions must be taken to prevent the mini glacier from damming natural water flows, and the natural waters feeding the reservoir must be sufficient to accumulate the additional ice. In other words, the reservoir must ordinarily have a sizable overflow in order to store much more winter ice. One should also note that as mini glaciers melt in the summer months, there is a sizable increase of available drinking water throughout summer drought seasons—a major concern of long-term water planners.

Recalling the minimum theoretical energy required just to aerosol water (44.2 j/kg), one can now estimate the minimum input energy to create a mini glacier of the above example (2.5×10¹⁴ cc). The calculation is straightforward: (44.2 j/kg)×(2.5×10¹¹ kg) or, 1.1×10¹³ joules. That theoretical minimum input energy must be produced over a brief period of perhaps 30 cold winter days and especially during the colder nights. Thus, 1.1×10¹³ joules over 30 days equates to 4.2 million watts or 4,200 kw for 30 days (˜$3 million) to space-cool 976,000 homes (˜$1/month per home) through the following entire summer. Such a reduction in power consumption per home, represents more than a 100 fold reduction in traditional space-cooling. Therefore, mini glacier technology not only contributes to global cooling even in winter months when least expected, it significantly expands reservoir holding capacities, and dramatically reduce summer space cooling costs. No allowance was made for the estimated pumping energy supplied by the water company to transport water to the aerosol deices. Clearly no water company would spend great sums to construct winter macro evaporators and save homeowners billions of dollars per decade without themselves deserving a portion of the energy savings. The point is that there is a wide margin for high profitability by water companies or, more likely, income to state or federal governments.

Thus, it is shown that even macro winter-evaporation offers multiple surprising results, especially when combined with potable water patent U.S. Pat. No. 6,688,129. Increased water storage is also important.

Winter space-heating is even more financially rewarding. In most populated parts of the world, conventional space-heating is several times more expensive than space cooling. However, in the following example, reservoirs are NOT required to store massive heat energy. That is accomplished by deep sequestered solar energy as detailed in section III. What is indeed profound about deeply sequestered solar energy is that, super high-temperature, high-pressure, solar energy can be stored (and retrieved) directly under mini glaciers, if so desired. As shown in FIG. 13, high temperature solar energy can be very efficiently stored for many months with only minor thermal losses. Deep thermal storage will not significantly contribute to melting mini glaciers far above the hot sequestered solar energy. Ironically, the very same reservoir real estate can serve as a convenient central energy storage and distribution point of both very hot AND very cold energy. In fact, as stated earlier, the very hot solar sequestration can also power super-efficient steam electric power plants. Water companies not only have the land and the water, but the existing infrastructure to deliver perfectly clean macro energy in the form of clean electricity, clean space-heating, clean space cooling, plus several times more potable water—all at a small fraction of current energy costs.

Macro heat sequestration/retrieval at extremely high temperatures is not essential to water companies if only space heating (and no electricity generation) is wanted. For example, if less than about 300° F. (148° C.) solar storage is desired (not 500-700° C.), the many boreholes depicted in FIG. 13, can be much shallower and correspondingly much less expensive. Computer modeling illustrates that thermal losses at lower temperatures is even more energy efficient. A borehole field, in typical damp earth/rock, having a typical specific heat capacity of 0.2 cal/cc/° C., can store enough thermal energy (1.05×10¹⁴ BTUs or 1.1×10¹⁷ joules) to heat 976,000 homes for an entire 90-day winter (the same number of homes as calculated for summer cooling above) if the borehole field measures about 152 meters×152 m×152 m (3.5 million cubic meters of earth) heated to about 150° C.

Conversely, water has ˜5 times the heat capacity of moist earth or rock. Instead of many boreholes, which use earth and rock as the thermal storage medium, a 5 times smaller man made cavern filled with cost-free water will suffice to sequester solar energy at only 300° F. (˜148° C.). If such a relatively shallow cavern (only hundreds, not thousands of feet deep) of hot water were to store the same 1.05×10¹⁴ BTUs of sequestered heat to space-heat the same number of homes (976,000), the resulting 750,000 m³ cavern would measure only 91 m×91 m×91 m and it can be inconspicuously located almost anywhere, even beneath an ice cold reservoir. Constructing liquid storage caverns is not prohibitively expensive (a few dollars per cubic yard) and cavern-technology is presently practiced in other countries for cryogenic liquid fuel megaton-storage. Giant boring technology is commonplace.

The main attraction to the above subterranean solar energy sequestration options is that solar energy can be continuously collected for 12 months of each year from smaller solar collection fields, because the collected hot energy is consumed during 90-day winters. Unlike prior art solar collection fields with extremely inefficient (15%) solar electric power generation, which consume the collected energy every day, very long-term solar energy storage allows a solar collection field to be considerably smaller and correspondingly less expensive. In the case at hand, solar energy is collected for 12 months but only consumed for 3 winter months, which is a duty factor of only 25%. Thus, unlike daily solar electric collection fields, the size and the cost of space-heating solar collection fields can be reduced by about 75%. Of course, all of this is useless unless the massive stored thermal energy can be delivered to everyone with the existing potable water delivery system disclosed in U.S. Pat. No. 6,688,129. With this greatly reduced solar collection field in mind, a cost estimation can be derived. Sandia Laboratories is a premier solar energy collection research center. They have employed Sargent and Lundy, LLC to independently authenticate the costs and future costs of solar collection fields.

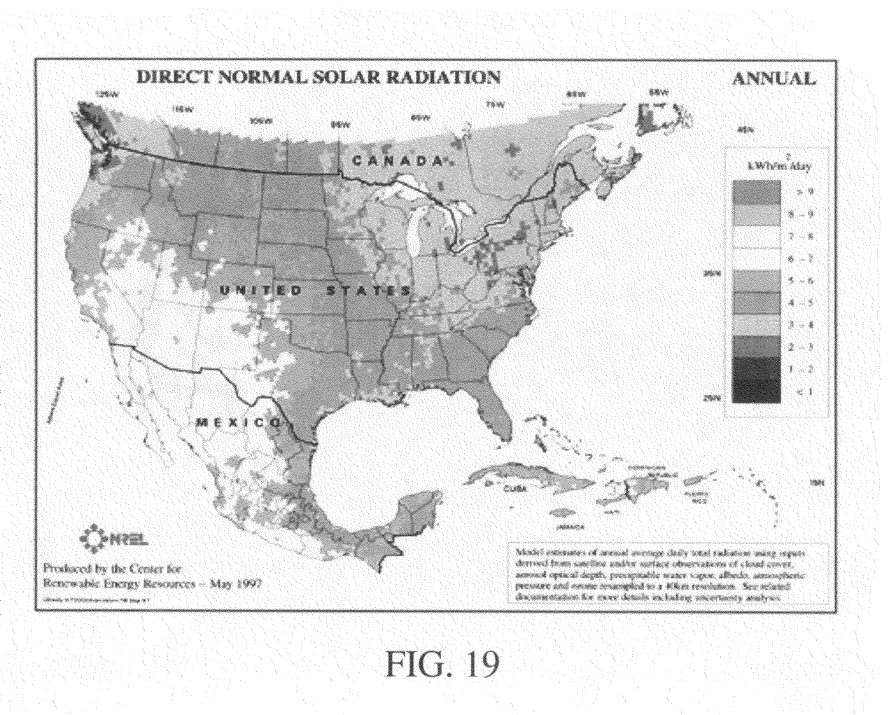

Sargent and Lundy (see Sargent and Lundy solar energy summary report at http://www.nrel.gov/csp/publications.html) has estimated the cost of solar collection fields at about $0.015 to $0.04 per kwh, depending on the location of the field and future technology improvements, which they claim “is likely”. Cloudless desert locations correspond to about 50% less expensive solar fields. Thus, we have a rough basis for estimating the cost of collecting and storing 1.05×10¹⁴ BTUs to heat 976,000 homes from an underground storage cavern. Since 1 kwh=3412 BTUs, the present 1.05×10″ BTU example calls for 3×10¹⁰ kwh costing as little as (3×10¹⁰ kwh×$0.015/kwh) or, a non-recurrent $450 million. In non-desert environments, that cost might double (see FIG. 19). However, one must compare this $450 million one-time cost with present day conventional space-heating costs sustained by 976,000 homes, which is typically $2 billion per year ($100 billion over a 50-year solar project life). A one-time solar field might cost only ˜1% of long-term conventional space-heating costs. Even if cavern tunneling-machines costs exceed $10/yd³, the 750,000 yd³ cavern in this example would total about $20 million—a small fraction (1%) of the solar collection field. Therefore, solar sequestration and recovery technology for space-heating is extremely cost effective—similar to the above ice space-cooling technology. However, in the case of space-heating cost savings, the absolute dollar savings (10's of billions of dollars) is much greater than space-cooling simply because heating is typically several times more expensive than cooling in most parts of the world. Once again, this enhanced form of U.S. Pat. No. 6,688,129 has extraordinary potential impacts on the global economy. The global space conditioning economic benefits actually far exceed the estimated costs to artificially cool the entire planet many degrees using the present invention's embodiments. The '129 energy savings are so great that local governments can also prosper while contributing to a global climate control system.

A common question frequently arises concerning where such large solar collection fields can be located. Some reservoir real estate properties might not be large enough to accommodate an entire solar field plus ice storage acreage. One unused and nearly ideal international land commodity exists—the unused land occupied by high-voltage power lines. Solar collector fields do not have to adjoin reservoir land. In fact, neither do caverns have to be located on reservoir property. Both the solar collectors and the underground thermal storage caverns can be located many miles from the reservoirs or the water companies. Computer modeling has proven that the thermal efficiency in rapidly transporting (pumping) 300° F. hot water over very long distances underground, to water companies, is remarkably efficient. Thus, since there are hundreds of thousands of miles of high voltage power lines, typically hundreds of feet wide, there are many millions of acres (billions of m²) of unused power line land available for many times more solar energy than needed for simple space-heating. Moreover, the concentration of power line acreage increases near large populations. There is a good match of power line land surface area and energy demand.

### X. The Invention Summary

From all the foregoing global warming and macro energy discussions, the embodiments of the present invention can be clearly defined and summarized:

Thousands of stationary and mobile macro evaporators distributed around the world aerosoling gigatons of water into receptive arid atmospheres, will create lightweight water vapors, which rapidly ascend to form thin, persistent clouds to reflect additional solar energy away from Earth and vapor-cool earth. Minimum input energy to aerosol and evaporate water is achieved by allowing aerosoled water to fall under gravity rather than employing macro air-blowers to create long aerosol hang times. Various types of aerosolation techniques known to the art may be employed. However, non-clogging “impact” aerosol technology is preferred over centrifugal nozzles. “Impact aerosolation” involves either high velocity water impacting fixed surfaces or, high velocity surfaces impacting slow motion water jets. Macro aerosol equipment can be switched on before sunrise and powered down during nights to minimize albedo heat trapping. Macro evaporators can be used during winter months to create mini glaciers in reservoirs or, for that matter, in either of Earth's Ferrel Cells to simultaneously form longevity clouds and more polar snow. The production of reservoir mini glaciers near potable water companies during winter months can be used for summer space cooling, while simultaneously contributing to global cooling.

Another preferred embodiment to cool Earth is macro solar energy sequestration as illustrated in FIGS. 13 and 18, wherein FIG. 18 is a cross-section of a typical enlarged fresh water reservoir showing artificial aerosoled ice storage and the two subterranean solar energy sequestration options. Sequestration, like aerosolation, can fully achieve the desired goal of global cooling. However, sequestration offers several additional options. Deep thermal sequestration far underground is equivalent to permanently ridding Earth of surface solar heat, similar to cloud solar reflections. Deep sequestration acts like well-insulated, nearly infinite energy vessels, allowing very high temperatures (greater than 100° C. or even 700° C.) to be stored under great pressures without eruptive boiling water. A portion of the deep high temperature sequestered energy can be retrieved to generate clean and perfectly reliable solar electricity. A sequestration option, illustrated in FIG. 18, offers concentrated mild heat storage in excess of 100° C., nearby potable water companies, for low-cost winter space heating. Furthermore, sequestration of solar energy can be combined with the above macro aerosol technology to cool Earth. In general, solar sequestration offers ways to power the entire global aerosol network, as well as storing many times more retrievable energy than mankind's entire energy needs. Thus, solar sequestration is so great (almost 50 times more energy than needed by mankind) that very low thermal-loss sequestration, very high loss sequestration, and moderate loss sequestration, all represent forms of solar cooling with unbound high energy-retrieval options.

The “Time Wave”© option described in section V (FIG. 16), is able to maintain potable water towers at either ice temperatures or at elevated temperatures, for space conditioning energy-distribution to entire communities. Moreover, the Time Wave© can be expanded to ensure that every potable water customer receives thermal energy stored in water towers. U.S. Pat. No. 6,688,129 covers the general subject of using existing potable water infrastructures for highly efficient, low-cost space conditioning.

### XI. Conclusions

This document focuses on correcting two distinctly different types of “global warming”—the small one called “human global warming” and the much larger one called “natural global warming”. It goes on to illustrate the enormity of the energy and power levels required to overcome such immense solar heating of Earth. The present invention rests its case on the extraordinary unexpected results of efficient scaling to “macro sizes”—gigaton evaporation and/or, petawatt sequestration with extremely low input energy. Heretofore, the scientific community has had no practical solution to either type of global warming. The present invention employs record “energy leverage” to profoundly reduce the input energy to accomplish the desired thermostatic end results. “Size” is not ordinarily a patentable subject—that is, unless “size” produces “surprising results”. Given the completely unaffordable and raging scientific debates over so called “solutions” to just solve “human” global warming—the present invention addresses and economically solves the far greater form of lethal natural global warming at many times less cost. Much moreover, if the macro-teachings of the present invention are wisely applied, both forms of global warming can be corrected—not with great financial liabilities, but with very large financial surpluses. This is just one of the several “surprising results” of macro sizing. Thus, the word “macro” completely reverses the expected global economics of climate control.

Examples of the unparalleled global economic boon offered by the present invention are provided:

The present invention proposes evaporating less than 1% more water into the atmosphere for the various reasons delineated. But, 1% more evaporated water produces several additional surprising results. 1% more precipitation automatically produces about 1% more hydroelectricity. The global installed hydroelectric capacity is presently 900 gigawatts. Thus, 1% more precipitation amounts to $10 billion in automatic increased revenues—one of many free byproducts of solving global warming.

The vast quantities of additional fresh water befalling Earth has a potential multi-trillion-dollar impact on all forms of vegetative and livestock agriculture—not to mention the means to reverse desertification and creating even more agricultural land.

Superficial discussions about “cloud albedo” frequently confuses the issue of global cooling. The fact is that clouds can indeed trap some thermal energy from escaping. However, the much more dominant controlling factor on Earth's temperature is the solar heater itself. The act of rejecting heat from ever reaching Earth not only cools the planet, it also reduces the amount of heat that is trapped. Thus, white clouds of every altitude, during daylight hours, help to cool Earth. Even white snow at zero altitude rejects solar heating. The distracting “albedo” effect is a relatively small second order issue.

Potable water is already a scarcity in many parts of the world. Although man has the means to desalinate ocean waters, desalination is not the issue. We need to transport vast quantities of fresh water TO people and at almost no cost. The present invention does just that in gigaton-proportions and at no extra cost. That alone is a nearly priceless byproduct of solving global warming.

A slight cooling of Earth by a few degrees of the more than 500° F. current solar heating also ensures less severe weather. Less destruction by less powerful hurricanes and tornados represents potential savings of many billions of dollars per year in less destruction, plus countless lives saved annually.

Although one of the present invention's preferred embodiments permanently sequesters solar energy deep underground (by fanning out the boreholes in FIG. 13), the very same solar sequestration process offers energy-retrieval options as well. As previously demonstrated, man must sequester about 0.6 petawatts to cool Earth. Mankind only uses about 0.013 petawatts for all of man's energy needs (coal, gas, oil, nuclear, etc). Clearly, retrieving only 2% of the sequestered solar energy for all of man's needs is very attractive. Thus, not only can all of man's space conditioning needs (˜25% of the total) be met by the present invention, all of his present electricity needs (˜39%) can also be met. Moreover, very quick charge (6 minute) 100%-electric vehicle research is literally rounding the final corners as we speak. Therefore, a small fraction of the sequestered solar energy is also able to meet another ˜28% of man's energy needs in the form of perfectly clean vehicular electric power, thereby eliminating another of the world's greatest pollution sources. Conventionally powered vehicles can be phased out and replaced with quiet and very efficient 100%-electric ground vehicles. The above three primary energy demands total approximately 25%+39%+28% or, about 92% of man's needs.

The option of very deep, very high temperature, solar sequestration offers a great opportunity to finally enter a true “solar age”. Prime solar energy has always been obstructed by not having an economic means to macro store solar energy for very long time periods. Low cost and efficient deep high temperature thermal sequestration represents the dawn of far more reliable, clean solar electricity than Man might ever need. The present global electrical consumption is a “mere” 4000 billion kwh—less than 0.1% of what must be sequestered to cool Earth. Thus, there are potential multi trillion dollar (per year) perfectly clean solar-electric power byproducts of one-time solar sequestration infrastructure costs. Professionals know that solar energy is most abundant in desert regions, but it not widely known that solar energy is very abundant almost everywhere else. FIG. 19 illustrates that the solar power flux over most of America is still greater than 50% of peak desert sun levels. FIG. 19 also illustrates where longevity cloud coverage would be most effective in cooling Earth—the arid cloudless zones—particularly in the warm 25° latitude to 35° latitude Ferrel Cells.

As illustrated in FIG. 19, solar power is very abundant everywhere. Even the northeast offers half as much solar power as the southwest. Solar sequestration is possible almost anywhere and so is very long term solar storage and retrieval possible almost anywhere. Macro solar storage is the dawn of a true “Solar Age”.

The present invention offers another tantalizing option. As stated in the text, if CO₂-free water were evaporated into the atmosphere, such CO₂-free atmospheric waters would thoroughly scavenge and automatically sequester gigatons of one of the great greenhouse gases from Earth. To the best knowledge presently available, no less-toxic, safer, or more cost efficient means exists to purge Earth's atmosphere of the present CO₂ greenhouse gases and effortlessly transport CO₂ to the oceans. This option is merely a potential byproduct option of vapor cooling Earth.

Without a doubt, our financially indebted global economy can certainly use a macro stimulus to employ an enormous number of people, worldwide. The present invention invites a revolution in space conditioning, electric power generation and transmission, ground transportation, potable water, manufacturing, and agriculture. The present invention represents an economic stimulus greater than any in recorded history. It represents an unprecedented paradigm shift to the dawn of solar energy.

“Inflict no harm” is a fundamental premise of the present invention. Water is most definitely our friend and protects us. It is well known that atmospheric water vapor is a powerful greenhouse gas. The present invention respects that by proposing to only evaporate about 0.01% to 1% more gaseous water into the atmosphere. Thus, unlike CO₂ greenhouse gases, which have risen over 50% in recent times, the proposed fraction of 1% increase in water greenhouse gases, is a negligible greenhouse gas.

Above and far beyond all of the previous tantalizing features inherent in the present invention, is the single necessity of preserving the world's seaports—our livelihood for food, energy, and goods. A mere 20-foot (or less) ocean rise (equal to less than one Greenland-ice-melt) can end life as we know it and threaten “billions of lives”. With both poles and all the world's glaciers rapidly melting; with desertification expanding; and already scarce fresh water dwindling, man risks literally everything by ignoring the big melt. Defrosting methane hydrates will accelerate global warming. A small temperature rise might very quickly lead to a methane release that can melt our glaciers even faster. Civilization itself is now defined by man's decisions to quickly correct a certain impending disaster. The window of opportunity is small. The present invention is the only known practical solution as well as the safest bet to avert an inevitable sequence unfolding before us. Some argue that “it's probably already too late”. The proper reply is: “it is definitely too late if we don't try”.

In conclusion, the present invention can be initiated at almost any affordable small scale and staged to macro proportions in order to self finance the entire planetary cooling system. The most immediate economic path to stable thermostatic planetary cooling is the easiest path—that of coupling patent U.S. Pat. No. 6,688,129 with solar sequestration and ice storage delivered by the existing multi trillion-dollar potable water infrastructure. Even the cost of purchasing '129 space conditioning apparatus is presently offset to a large extent by approved energy tax incentives. The remaining costs (if any), can be collected by water companies through regular water-billing to fully recover '129 installation costs through energy savings. The annual energy savings can more than cover small monthly billings. But the energy savings literally instantly increase real estate values by 20 times the energy savings (i.e. $40,000 higher appraisals on $2,000 savings)! The apparatus of U.S. Pat. No. 6,688,129 can pay for itself quite rap-idly, with immediate energy savings. So great are the energy savings that legislated energy savings can be shared by states to reduce taxes. State-owned, federally owned and privately held water companies have no regulatory obstacles barring the deployment of the present invention or patent '129. States can even legislate activities to speed up the economic boon. The issue at hand is one of rapidly, very rapidly, affording the means to cool Earth in time. The present invention offers all the options.

Such ambitious macro programs take decades to mature, and no one knows for sure if we actually have decades before it is too late. Ignoring the issue is a certain long term fatal option. Not one proposed prior art solution is viable. Unabated human, and especially natural climate changes can cost mankind in excess of $200 trillion over the next century—an unbearable burden on a mere $63 trillion global economy. And that toll completely ignores putting literally billions of lives at risk. The comprehensive present invention is the first safe, immediately implementable, and even prosperous solution to global climate control. Cost is no longer an obstacle. Technology is not an obstacle. And, if Man's willpower alone cannot meet this great need, then unprecedented prosperity certainly can.

What is claimed is:

1. A method to reduce human greenhouse as well as natural global warming, comprising:
evaporating, by way of multiple aerosol-evaporators, vast quantities of water to produce water vapors for cooling atmospheric air masses; causing lightweight water vapors to naturally rise and condense at high altitudes to form clouds; and thereby liberating vast amounts of high altitude infrared radiation, as said clouds form, to further cool earth by way of solar radiation reflected into space.

2. A method of claim 1, further including operating seawater-pumping means at sufficiently high pressure to both elevate and aerosol seawater into sufficiently small droplets to substantially evaporate before falling back to earth, to form said water vapors.

3. Apparatus for cooling the earth's atmosphere to reduce global warming, comprising:
evaporators for producing particles of water; and a blower mechanism to disperse the evaporating water particles in the atmosphere.

4. The apparatus of claim 3, wherein said evaporators are located in sufficiently arid locations, such as near sparsely-populated desert shorelines or on sparsely populated islands; and in natural prevailing air-currents, such as (but not limited to) earth's Ferrel and Arctic Cell air currents, to carry water vapors upward to condense and ultimately precipitate it as rain or snow, where the greatest benefits are realized, such as locations where such snow would continuously reflect even more solar radiation into space by snow, to enhance agricultural rain and provide fresh drinking water, or to restore melting glaciers to avoid global flooding.

5. The apparatus of claim 4, wherein the blower and/or the evaporators are powered directly or indirectly by solar energy as thermal energy stored in deep caverns.

6. The apparatus of claim 4, wherein the blowers or evaporators are powered by any other power source, such as clean hydroelectricity, nuclear power, deep geothermal power or, by other conventional power sources.

7. The apparatus of claim 4 where said evaporators include aerosol generators having large, non clogging, exit-orifices, located in the center of centrifugal housings fed tangentially by high velocity water from water pumps of sufficient pressure to form small water droplets which largely evaporate before falling to earth.

8. The apparatus of claim 4 wherein said evaporators are remotely controllable to regulate or limit the entire planet's average cooling rate or, to switch the evaporators down or off when weather conditions, such as high humidity, warrant it.

9. A method and apparatus to cool the planet by optically collecting and permanently sequestering solar energy as extremely hot water deep in vast natural or manmade caverns, instead of, or in conjunction with, radiating solar energy back into space in accordance with the method of claim 1.

10. The method and apparatus of claim 9, wherein extremely hot cavern-water may be injected or extracted on demand to power the aerosol-evaporation apparatus to reduce human greenhouse and natural global warming or, if so desired, power any other apparatus such as numerous thermal electric power plants or other industrial thermally-powered apparatus.
